(19) United States
(12) Patent Application Publication
(10) Pub. No.: US 2024/0167815 A1
(43) Pub. Date: May 23, 2024

(54) METAMATERIAL-BASED DEFORMATION SENSING SYSTEM

(71) Applicant: Infineon Technologies AG, Neubiberg (DE)

(72) Inventors: Alexander SCHOSSMANN, Graz (AT); Alexander BERGMANN, Graz (AT); Dirk HAMMERSCHMIDT, Finkenstein (AT); Christof MICHENTHALER, Feistritz an der Gail (AT)

(21) Appl. No.: 18/465,666

(22) Filed: Sep. 12, 2023

Related U.S. Application Data
(60) Provisional application No. 63/384,674, filed on Nov. 22, 2022.

(51) Int. Cl. G01B 15/06; G01L 1/14

(52) U.S. Cl. CPC G01B 15/06; G01L 1/14

(57) ABSTRACT

A sensor system includes a first flexible substrate configured to undergo a deformation in response to a force applied to the first flexible substrate or an environmental condition to which the first flexible substrate is exposed; a first metamaterial layer mechanically coupled to the first flexible substrate, wherein the first metamaterial layer comprises a first array of conductive elements that are mutually coupled by a first strain-dependent coupling that changes based on the deformation of the first flexible substrate; at least one transmitter configured to transmit a first electromagnetic transmit wave towards the first metamaterial layer, wherein the first metamaterial layer is configured to convert the first electromagnetic transmit wave into a first electromagnetic receive wave based on the first strain-dependent coupling; and at least one receiver configured to receive the first electromagnetic receive wave and acquire a first measurement of a first property of the first electromagnetic receive wave.

### CROSS REFERENCE TO RELATED APPLICATION

This Patent Application claims priority to U.S. Provisional Patent Application No. 63/384,674, filed on Nov. 22, 2022, and entitled “METAMATERIAL-BASED DEFORMATION SENSING SYSTEM.” The disclosure of the prior Application is considered part of and is incorporated by reference into this Patent Application.

### BACKGROUND

Vehicles feature numerous safety, body, and powertrain applications that rely on speed sensing, position sensing, angle sensing, and/or torque sensing. For example, in a vehicle's Electronic Stability Program (EPS), magnetic angle sensors and linear Hall sensors can be used to measure steering angle and steering torque. Modern powertrain systems can rely on magnetic speed sensors for camshaft, crankshaft and transmission applications, along with automotive pressure sensors, to achieve required CO2 targets and smart powertrain solutions. However, a disadvantage of known solutions is that they are sensitive to magnetic disturbances.

Magnetic disturbance fields are prevalent in vehicles such that magnetic angle-measurements often have to endure harsh environments. This is especially problematic in hybrid and electric vehicles, where many wires with high currents are located near the sensor system. Thus, external magnetic disturbance fields may be generated by current-rails in a vehicle that influence the accuracy of the magnetic angle measurements. Thus, sensors that are robust against electromagnetic stray fields may be desirable.

Strain gauges may be one type of sensor that is used for performing strain measurements that can be used to determine torque. Typically, the higher the applied torque, the higher the strain. Strain gauges comprise thin wires fabricated on a flexible insulator substrate. Deformation to the flexible insulator substrate changes the geometry of the wires and thus causes a change in their resistivity. However, these types of strain gauges have several disadvantages. One disadvantage is that these strain gauges have a cross-sensitivity to environmental conditions, such as temperature and atmospheric pressure. Thus, as environmental conditions change, measurement results can change and lead to inaccurate measurements Another disadvantage is that these strain gauges require power supply. Furthermore, these types of strain gauges are limited regarding their scalability. For example, the wires cannot be made arbitrary thin as they are then prone to overheating and the operating voltage would have to be decreased significantly, which is not always possible.

Torque sensors that are based on strain gauges are cost-effective. However, the main problem is sensor read-out. In order to measure rotary torque, an elaborate solution for the energy supply of the circuitry of the strain gauges is mandatory. There are two types of instrumentation: indirect measurement and non-contact measurement. For indirect measurement, the strain gauges are placed on stationary parts of the measurement object. The main problem with indirect measurement is the cross-sensitivity to deformations that do not come from the torque to be measured. Further issues include low reliability and high maintenance. As a result, indirect measurement is rarely used. For non-contact measurement, strain gauges are placed on moving or rotating parts of the measurement object. However, power transfer to the strain gauge and sensor read-out require an elaborate solution.

Surface acoustic wave (SAW) devices can be used as torque sensors. SAW torque sensors are bonded onto the measurement object. The surface strain, caused by an applied force or torque, changes their characteristic resonance frequency. Telemetric read-out is performed using interdigital transducers, which are part of SAW components. However, one disadvantage is that the sensitivity of SAW components is strongly dependent on temperature and required temperature compensation for accurate measurements. Another disadvantage is that the RF frequencies, used for the telemetric read-out, have to be chosen carefully in order to avoid disturbance of electromagnetic interferences. For present-day SAW components, these RF frequencies lie between 10 MHz and 3 GHz. Another disadvantage is that the surface of SAW components must not be damaged, which requires elaborate shielding, especially in a harsh environment such as those existing in automotive systems.

Magnetostrictive torque sensors is another type of torque sensor. These are based on inverse magnetostriction. An applied strain causes a change in the magnetization. This principle is inherently contact-less. It requires a suitable material for a rotating shaft which is either pre-magnetized or ferromagnetic. For the latter, complex electronics are needed that induce the magnetization and have a corresponding additional power consumption. Furthermore, the system is not telemetric and only works for small distances (less than 1 cm) between the shaft and the sensor reading head.

Accordingly, a strain sensor that overcomes at least one or more of the above disadvantages may be desirable. For example, a sensor system that provides a cost-effective solution for measuring stress resulting from at least one applied force or environmental condition and that is robust against electromagnetic stray fields may be desirable.

### SUMMARY

One or embodiments provide a sensor system, including: a first flexible substrate configured to undergo a deformation in response to at least one force applied to the first flexible substrate or an environmental condition to which the first flexible substrate is exposed; a first metamaterial layer mechanically coupled to the first flexible substrate, wherein the first metamaterial layer comprises a first array of conductive elements that are mutually coupled by a first strain-dependent coupling that changes based on the deformation of the first flexible substrate; at least one transmitter configured to transmit a first electromagnetic transmit wave towards the first metamaterial layer, wherein the first metamaterial layer is configured to convert the first electromagnetic transmit wave into a first electromagnetic receive wave based on the first strain-dependent coupling; and at least one receiver configured to receive the first electromagnetic receive wave and acquire a first measurement of a first property of the first electromagnetic receive wave.

One or more embodiments provide a sensor system that includes a waveplate. The waveplate incudes a first flexible substrate configured to undergo a deformation in response to at least one force applied to the first flexible substrate or an environmental condition to which the first flexible substrate is exposed; and a first metamaterial layer mechanically coupled to the first flexible substrate. The first metamaterial layer comprises a first array of conductive elements that are mutually coupled by a first strain-dependent coupling that changes based on the deformation of the first flexible substrate. Based on the first strain-dependent coupling, the first metamaterial layer is configured to convert a first polarized electromagnetic wave having a first polarization into a second polarized electromagnetic wave having a second polarization different from the first polarization.

One or more embodiments provide a sensor system that includes a waveplate. The waveplate includes a first flexible substrate configured to undergo a deformation in response to at least one force applied to the first flexible substrate or an environmental condition to which the first flexible substrate is exposed; a first metamaterial layer mechanically coupled to the first flexible substrate, wherein the first metamaterial layer comprises a first array of conductive elements that are mutually coupled by a first strain-dependent coupling that changes based on the deformation of the first flexible substrate, wherein the first strain-dependent coupling includes at least one of capacitive coupling or inductive coupling; and a linearly polarizing layer configured to polarize electromagnetic waves into a predetermined linear polarization. The sensor system further includes a reflective structure configured to reflect electromagnetic waves; a transmitter configured to transmit an electromagnetic transmit wave; and a receiver. The linearly polarizing layer is configured to convert the electromagnetic transmit wave into a first polarized electromagnetic wave having a first polarization corresponding to the predetermined linear polarization. Based on the first strain-dependent coupling, the first metamaterial layer is configured to convert the first polarized electromagnetic wave into a second polarized electromagnetic wave having a second polarization. The reflective structure is configured to receive and reflect the second polarized electromagnetic wave, thereby converting the second polarized electromagnetic wave into a third polarized electromagnetic wave having a third polarization. Based on the first strain-dependent coupling, the first metamaterial layer is configured to convert the third polarized electromagnetic wave into a fourth polarized electromagnetic wave having a fourth polarization, wherein the fourth polarization is different from the first polarization and a difference between the first polarization and the fourth polarization changes based on the first strain-dependent coupling. The receiver configured to receive at least a portion of the fourth polarized electromagnetic wave, acquire a first measurement of the fourth polarized electromagnetic wave, and determine a strain resulting from the at least one force applied to the first flexible substrate or the environmental condition to which the first flexible substrate is exposed based on the first measurement.

### BRIEF DESCRIPTION OF THE DRAWINGS

Embodiments are described herein making reference to the appended drawings.

FIG. 1A illustrates a plurality of possible elementary structures according to one or more embodiments;

FIG. 1B illustrates different types of capacitively coupled elementary structures according to one or more embodiments;

FIG. 1C illustrates different types of inductively coupled elementary structures according to one or more embodiments;

FIGS. 2A and 2B illustrate segments of a mm-wave metamaterial array according to one or more embodiments.

FIG. 3 illustrates a deformation principle according to one or more embodiments.

FIGS. 4A and 4B illustrate strain sensor systems according to one or more embodiments.

FIG. 5 is a block diagram that illustrates a transceiver circuit of a transceiver according to one or more embodiments.

FIGS. 6A and 6B illustrate strain sensor systems according to one or more embodiments.

FIGS. 6C and 6D respectively illustrate top and side views of a strain sensor system according to one or more embodiments.

FIGS. 7A and 7B illustrate strain sensor systems according to one or more embodiments.

FIGS. 7C and 7D respectively illustrate top and side views of a strain sensor system according to one or more embodiments.

FIGS. 8A and 8B illustrate segments of common metamaterial layers according to one or more embodiments.

FIG. 9A is a side view of a strain sensing system according to one or more embodiments.

FIG. 9B is a side view of a strain sensing system according to one or more embodiments.

FIGS. 10A and 10B respectively illustrate side and top views of a strain sensing system according to one or more embodiments.

FIGS. 11A and 11B respectively illustrate side and top views of a strain sensing system according to one or more embodiments.

FIG. 11C illustrates a side view of a strain sensing system according to one or more embodiments.

FIG. 12 illustrates some example anisotropic metamaterial elementary structures according to one or more embodiments.

FIG. 13 illustrates a principle of anisotropy with respect to anisotropic metamaterial elementary structures according to one or more embodiments.

FIG. 14A illustrates a strain sensor system according to one or more embodiments.

FIG. 14B illustrates front view of a quarter waveplate used in the strain sensor system illustrated in FIG. 14A according to one or more embodiments

FIG. 14C illustrates a strain sensor system according to one or more embodiments.

FIG. 14D illustrates a strain sensor system according to one or more embodiments.

FIG. 15 illustrates a strain sensor system according to one or more embodiments.

FIG. 16A illustrates a strain sensor system according to one or more embodiments.

FIG. 16B illustrates front view of a half waveplate used in the strain sensor system illustrated in FIG. 16A according to one or more embodiments.

### DETAILED DESCRIPTION

In the following, details are set forth to provide a more thorough explanation of the exemplary embodiments. However, it will be apparent to those skilled in the art that embodiments may be practiced without these specific details. In other instances, well-known structures and devices are shown in block diagram form or in a schematic view rather than in detail in order to avoid obscuring the embodiments. In addition, features of the different embodiments described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

In this regard, directional terminology, such as “top”, “bottom”, “below”, “above”, “front”, “behind”, “back”, “leading”, “trailing”, etc., may be used with reference to the orientation of the figures being described. Because parts of embodiments can be positioned in a number of different orientations, the directional terminology is used for purposes of illustration. It is to be understood that other embodiments may be utilized and structural or logical changes may be made without departing from the scope defined by the claims. The following detailed description, therefore, is not to be taken in a limiting sense. Directional terminology used in the claims may aid in defining one element's spatial or positional relation to another element or feature, without being limited to a specific orientation.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In embodiments described herein or shown in the drawings, any direct electrical connection or coupling, i.e., any connection or coupling without additional intervening elements, may also be implemented by an indirect connection or coupling, i.e., a connection or coupling with one or more additional intervening elements, or vice versa, as long as the general purpose of the connection or coupling, for example, to transmit a certain kind of signal or to transmit a certain kind of information, is essentially maintained. Features from different embodiments may be combined to form further embodiments. For example, variations or modifications described with respect to one of the embodiments may also be applicable to other embodiments unless noted to the contrary.

The terms “substantially” and “approximately” may be used herein to account for small manufacturing tolerances (e.g., within 5%) that are deemed acceptable in the industry without departing from the aspects of the embodiments described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

One or more aspects of the present disclosure may be implemented as a non-transitory computer-readable recording medium having recorded thereon a program embodying methods/algorithms for instructing the processor to perform the methods/algorithms. Thus, a non-transitory computer-readable recording medium may have electronically readable control signals stored thereon, which cooperate (or are capable of cooperating) with a programmable computer system such that the respective methods/algorithms are performed. The non-transitory computer-readable recording medium can be, for example, a CD-ROM, DVD, Blu-ray disc, a RAM, a ROM, a PROM, an EPROM, an EEPROM, a FLASH memory, or an electronic memory device.

One or more elements of the present disclosure may be configured by implementing dedicated hardware or a software program on a memory controlling a processor to perform the functions of any of the components or combinations thereof. Any of the components may be implemented as a central processing unit (CPU) or other processor reading and executing a software program from a recording medium such as a hard disk or a semiconductor memory device. For example, instructions may be executed by one or more processors, such as one or more CPUs, digital signal processors (DSPs), general-purpose microprocessors, application-specific integrated circuits (ASICs), field programmable logic arrays (FPGAs), programmable logic controller (PLC), or other equivalent integrated or discrete logic circuitry.

Accordingly, the term “processor,” as used herein refers to any of the foregoing structures or any other structure suitable for implementation of the techniques described herein. A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (i.e., measurement signals) from one or more components in the form of raw measurement data and may derive, from the measurement signal further information. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a signal suitable for processing after conditioning.

It will be appreciated that the terms “sensor”, “sensor element”, and “sensing element” may be used interchangeably throughout this description, and the terms “sensor signal” and “measurement signal” may also be used interchangeably throughout this description.

Embodiments are discussed below in the context of a millimeter wave (mm-wave) sensor and mm-wave systems that include a mm-wave transmitter, a mm-wave receiver, and/or a mm-wave transceiver. Mm-waves are radio waves designated in the band of radio frequencies in the electromagnetic spectrum from 30 to 300 gigahertz (GHz) and may also be used as radar waves. Thus, a mm-wave sensor, system, transmitter, receiver, or transceiver described herein may also be regarded to as a radar sensor, system, transmitter, receiver, or transceiver, and a mm-wave may be regarded to as a radar signal. It should be noted, however, that the embodiments may also be applied in applications different from radar such as, for example, radio frequency (RF) transmitters, receivers, or transceivers of RF communication devices. In fact, any RF circuitry may take advantage of the concepts described herein. A mm-wave sensor or mm-wave system may be configured as an angle sensor, a rotary position sensor, a linear position sensor, a speed sensor, a motion sensor, and/or a torque sensor.

A metamaterial is a material engineered to have a property that is not found in naturally occurring materials. They are made from assemblies of multiple structural elements fashioned from composite materials such as metals or plastics. The materials may be arranged in repeating or periodic patterns, at scales that are smaller than the wavelengths of the phenomena they influence. In other words, metamaterials attain the desired effects by incorporating structural elements of sub-wavelength sizes, i.e., features which are actually smaller than the wavelength of the electromagnetic waves that they affect.

As a result, metamaterials derive their properties not necessarily from the properties of the base materials, but from their designed structures. Their precise shape, geometry, size, orientation, and arrangement of the structural elements gives the metamaterials their smart properties capable of manipulating electromagnetic waves: by blocking, reflecting, absorbing, enhancing, or bending waves, to achieve benefits. Thus, a metamaterial is defined as an artificial composite that gains its electrical properties from its exactingly-designed structures and their arrangement rather than inheriting them directly from which the materials it is composed.

A metamaterial may be a subset of a larger group of heterogeneous structures consisting of a base solid material and elements of a different material. The distinction of metamaterials is that they have special, sometimes anomalous, properties over a limited frequency band. For example, mm-wave metamaterials may exhibit special properties over a millimeter band, which is the band of spectrum between 30 GHz and 300 GHz noted above.

In the context of the described embodiments, a metamaterial is a two-dimensional (2D) or three-dimensional (3D) array of elementary structures, which are coupled to each other. “Elementary structures,” as used herein, may be referred to as discrete structures, element structures, or a combination thereof. In some cases, the elementary structures may be referred to simply as “structures.” Elementary structures themselves may be composed of one or more conductive elements. When composed of two or more conductive elements, the conductive elements of an elementary structure may be mutually coupled to each other by, for example, a capacitive coupling, inductive coupling, or galvanic coupling. Additionally, the conductive elements of adjacent elementary structures may be mutually coupled to each other by, for example, a capacitive coupling, inductive coupling, or galvanic coupling. These couplings may be referred to as “strain-dependent couplings.”

The overall array of elementary structures provides macroscopic properties, which can be designed by the used elementary structures and their coupling paths. Metamaterials are configured for different kind of waves like electromagnetic waves (e.g., optical, infrared (IR), and mm-waves) and mechanical waves (e.g., ultrasonic). The scale of the elementary structures and their grid pitch scale with the wavelength of the target frequency range.

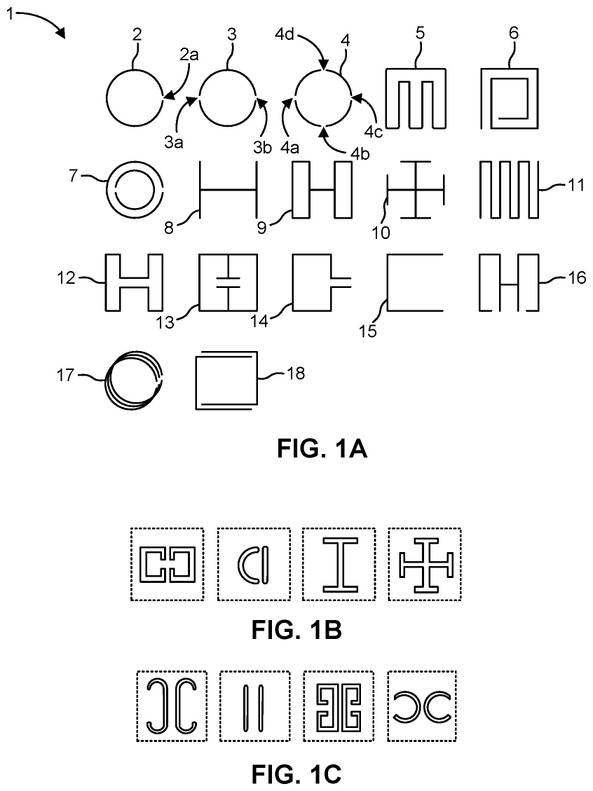

Elementary structures in mm-wave metamaterials may include resonator-elements, antenna-elements, filter-elements, waveguide-elements, transmission line elements, or a combination of those shown in FIG. 1A. The elementary structure size may range up to several wavelengths but is typically below one wavelength. They consist of parts that generate magnetic fields (e.g., conductor rings) and other parts that create electrical fields (e.g., gaps between conductors). Furthermore, they also may have elements that have electromagnetic wave properties, such as a short transmission line segment.

In general, those elementary structures electrically represent resistive-inductive-capacitive (RLC) networks. In the frequency range where they will be used in the meta material, the characteristic of their resistive, inductive, and capacitive parameters is distributed over the geometry. Since filters, resonators, transmission lines, and antennas can be differently parametrized representatives of identical structures it is often not unambiguously possible to assign a structure to a single group. Thus, it is to be understood that a structure described as resonator can also be seen as antenna or a filter depending on its use or implementation details. Furthermore, the behavior may also change with the frequency where it is operated and a structure that behaves as transmission line for one frequency may also expose a filter characteristic or create a resonance at another frequency of operation. Finally, the choice of the material impacts the behavior which means that a choice of a better conductor will emphasize a resonant behavior while a less conductive material will increase the damping and make a filter characteristic dominant.

FIG. 1A illustrates a plurality of possible elementary structures according to one or more embodiments. The elementary structures 1 include a split ring resonator 2 having one capacitor coupling 2a, a split ring resonator 3 having two capacitor couplings 3a and 3b, a split ring resonator 4 having four capacitor couplings 4a-4d, antenna structure 5, an antenna coil 6, a nested split ring resonator 7, antenna structure 8, antenna structure 9, antenna structure 10, transmission line structure 11, antenna structure 12, coupled split ring resonators 13, split ring resonator 14, partial ring or coupling structure 15, and coupled split ring resonator 16.

The transmission line structure 11 may be a damping structure or delay structure. It may be used in an alternating configuration with resonators in order to establish an attenuated or phase shifted coupling between them instead of coupling directly. Coupling to the resonators can be capacitive or galvanic. It may also extend onto a second layer, for example, with an identical structure creating a real transmission line (i.e., two parallel wires).

The partial ring or coupling structure 15 may be referred to as a partial ring structure in the context of it being half of a split ring resonator 18. In this context, the partial ring structure 15 is coupled to a second layer to form a resonator.

Furthermore, the elementary structures can be three-dimensional as well, such as spiral coils and nested split ring resonators that are oriented into all three Cartesian coordinate directions. Furthermore, three-dimensional structures can be generated by layering two-dimensional elementary structures in a stacked arrangement. For example, two elementary structures may be layered over one another in a vertical dimension so that they overlap with each other. In this way, a vertical capacitive coupling may be achieved between the two elementary structures and may be adjusted by varying an amount of overlap in a horizontal dimension.

FIG. 1A further illustrates a stacked split ring resonator structure 17 having three split ring resonators stacked on top of each other. The stacked split ring resonator structure 17 may be formed by using three metallization layers stacked on top of each other. FIG. 1A further illustrates a split ring resonator 18 made of two half-ring structures 15 that overlap such that a vertical capacitive coupling exists between the two half-ring structures. By varying the amount of overlap, the loop size can be made larger (e.g., by decreasing the amount of overlap) or smaller (e.g., by increasing the amount of overlap), which in turn results in a lower vertical capacitive coupling or a higher vertical capacitive coupling, respectively.

In order to achieve a quasi-homogeneous macroscopic behavior, the elementary structures are arranged in arrays which typically have dimensions that are larger than a wavelength of the target frequency range and include a multitude of elementary structures in each utilized direction.

FIG. 1B illustrates different types of capacitively coupled elementary structures according to one or more embodiments. Each of the elementary structures contains conductive elements (i.e., structures) that are mutually coupled via a capacitive coupling, either within the elementary structure itself or to a conductive element of a neighboring elementary structure. Each type of elementary structure may be repeated in an array of elementary structures.

FIG. 1C illustrates different types of inductively coupled elementary structures according to one or more embodiments. Each of the elementary structures contains conductive elements that are mutually coupled via an inductive coupling, either within the elementary structure itself or to a conductive element of a neighboring elementary structure. Each type of elementary structure may be repeated in an array of elementary structures.

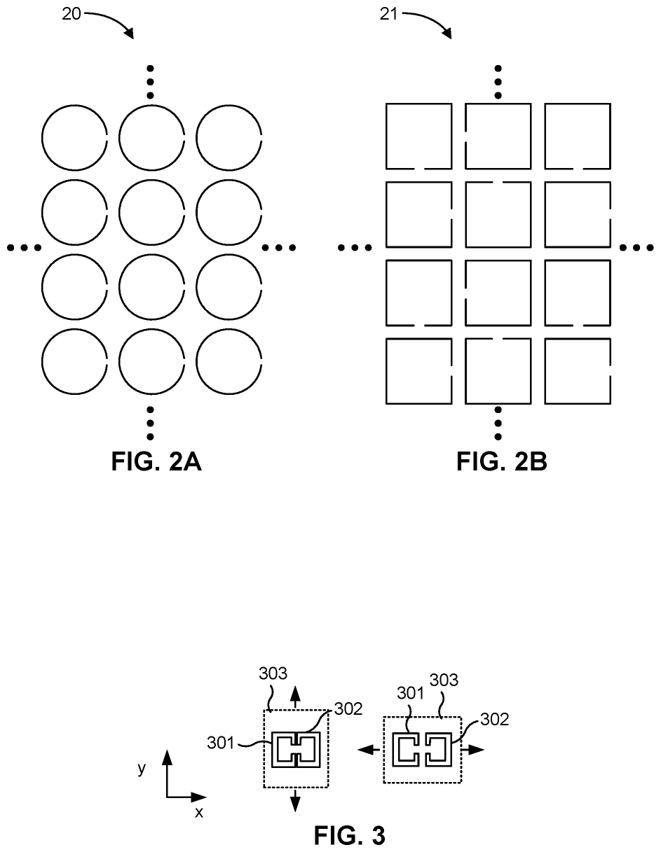

FIGS. 2A and 2B illustrate segments of a mm-wave metamaterial array according to one or more embodiments. A mm-wave metamaterial array has multiple elementary structures arranged in both widthwise and lengthwise dimensions. The mm-wave metamaterial array by be formed in a metamaterial layer that is mechanically coupled to a flexible substrate. The flexible substrate can be a block, a plate, a wheel, a rotatable shaft, or a carrier substrate that is mechanically fixed to a plate, a wheel, a rotatable shaft, or any other structure or component that may undergo strain, causing a deformation thereto that imposes a positional shift to the conductive elements of a metamaterial array to be measured.

If the flexible substrate undergoes a deformation, for example, in response to at least one force applied to the flexible substrate or to an environmental condition to which the flexible substrate is exposed, the deformation of the flexible substrate causes the positional shift of the conductive elements within the array relative to each. For example, a force applied to the flexible substrate may cause the flexible substrate to compress, contract, expand, stretch, twist, or deform in any other way in any direction. Similarly, an environmental condition such as an ambient temperature or external pressure may cause the flexible substrate to compress, contract, expand, stretch, twist, or deform in any other way in any direction.

As a result of a deformation to the flexible substrate, conductive elements within the elementary structures or conductive elements of neighboring elementary structures may shift positionally, for example, closer together or further apart relative to each other. This causes at least one of capacitive coupling, inductive coupling, or galvanic coupling to change relative to (e.g., proportional to) the positional shift in conductive elements. For example, a coupling may become stronger or weaker, thereby changing how the mm-wave metamaterial array interacts with a mm-wave. Since the positional shift in conductive elements is indicative of a strain experienced by the flexible substrate, the strain can be measured by measuring a property (e.g., a millimeter (mm)-wave property) of the mm-wave metamaterial array that is affected by the positional shift in conductive elements. This property can be one or more of the capacitive, inductive, or galvanic couplings described above. As a result, these couplings may be referred to as “strain-dependent couplings.” A change in the property of the mm-wave metamaterial array can affect and induce a change in a phase shift, an amplitude shift, and/or a polarization shift of an electromagnetic wave (e.g., a mm-wave) that has interacted with the mm-wave metamaterial array.

It is important to note that while a positional shift between conductive elements may occur, the positional shift occurs without deforming or substantially deforming a geometry of the conductive elements of the mm-wave metamaterial array. This is due to the difference in the Young's modulus of the material of the conductive elements and the Young's modulus of the material of the flexible substrate. For example, the conductive elements of the mm-wave metamaterial array may a first Young's Modulus and the flexible substrate may have a second Young's Modulus that is greater than the first Young's Modulus by a factor of at least 10,000. Thus, the flexible substrate is configured to deform, while the geometry of the conductive elements is configured to remain substantially unchanged. In this way, it can be said that the deformation of the flexible substrate causes the positional shift of the conductive elements of the mm-wave metamaterial array relative to each while a geometry of the conductive elements of the mm-wave metamaterial array remains substantially unchanged based on a difference between the first Young's Modulus and the second Young's Modulus.

Specifically, FIG. 2A shows an example of a 2D array 20 of split ring resonators, which are expected to extend further in both horizontal and vertical directions. However, it will be appreciated that the split ring resonators may be exchanged with any type of elementary structure, for example, with any of those shown in FIGS. 1A-1C. Each split ring resonator comprises an open ring that represents an inductivity (L) and a gap or opening that provides a capacitive coupling (C). Thus, each split ring resonator is a type of LC resonator.

In this example, the split ring resonators in each row are arranged in the same position and orientation. Furthermore, the spacing between adjacent split ring resonators is shown. One or more properties between the structures, such as spacing and orientation, may change in response to a deformation of the flexible substrate.

There exists a mutual coupling of the structures in the array 20, which can be a capacitive coupling, an inductive coupling, a galvanic coupling, or any combination thereof. In the case of FIG. 2A, both capacitive coupling and inductive coupling are present. For example, capacitive coupling between structures exists in the vertical direction on the sides where rings are close together. In addition, inductive coupling between structures is provided by the field generated by each split ring resonator.

Thus, electrically, the arrangement of the elementary structures in an array introduces a mutual coupling between the elementary structures, wherein the coupling effect may utilize electric field (capacitive near field coupling), magnetic field (inductive near field coupling), waveguide coupling, or electromagnetic waves (far field coupling). Due to the dimensions of the arrays and depending on the type of used elementary structures, the coupling effect will typically made up of a mixture of all mechanisms.

The manner in which the structures are coupled affects the coupling behavior of the array or a portion of that array. In turn, this coupling behavior impacts an effect the individual structures or a group of structures have on a transmission wave or signal incident on that structure or that group of structures.

Furthermore, the coupling effect between structures is different if gaps or openings of neighboring structures are face-to-face or if the gaps face (i.e., are adjacent to) a closed segment of a neighboring structure. For example, FIG. 2B shows an example of 2D array 21 of split ring resonators in which an orientation of the split ring resonators changes in both the horizontal (width) and vertical (length) directions of the array 21 (i.e., of the metamaterial array). In other words, the location of the gap of each split ring resonator varies across neighboring structures and the rows of structures have different patterns. Here, while not required, it is possible that each row of structures has a unique pattern. As a result, the coupling effect between structures in FIG. 2B is different than the coupling effect produced by the structures shown in FIG. 2A.

Furthermore, the coupling effect between structures in FIG. 2B changes partially along the array in the rotation direction, whereas the coupling effect between structures in FIG. 2A does not change along the array in the rotation direction. The different shapes (circular versus rectangular) may also impact the characteristic of the structure itself and the coupling effect.

Each elementary structure has a size (e.g., a width or diameter) of 10% to 100% of the wavelength of a transmitted mm-wave to which the structure is sensitive. The array 20 may be a single metallization layer disposed or printed on a film such that the array 20 is two-dimensional. As noted above, it may also be possible to stack multiple metallization layers to form a 3D array.

Thus, arrays of elementary structures described herein include multiple repetitions of element structures having same or differing arrangements with respect to each other that induce a property on a transmission wave or signal incident thereon due to the coupling effect between the structures and, specifically, between respective conductive elements.

As will become apparent in the following description, one or more mm-wave metamaterial arrays may also be used to perform strain measurements pertaining to at least one force applied to a flexible substrate or an environmental condition to which the flexible substrate is exposed. One or more applied forces may relate to a torque applied to the flexible substrate that causes the flexible substrate to deform (e.g., twist), which would cause a positional shift of the conductive elements relative to each other. The amount applied torque is proportional to the strain experienced by the flexible substrate and detectable by the herein-described strain sensor systems. Thus, an amount of torque can be determined from a strain measurement.

As another example, different ambient temperatures can cause the flexible substrate to deform (e.g., contract or expand), which would cause a positional shift of the conductive elements relative to each other. For example, conductive elements of the elementary structures could shift closer together or further apart as a result of the deformation of the flexible substrate. In this way, the positional shift is related to (e.g., proportional to) the ambient temperature.

The overall metamaterial has characteristic reflection spectra based on the characteristic resonant behavior of the elementary structures. These characteristic resonances strongly depend on shape and geometry of the elementary structures, as well as the position of the elementary structures relative to each other. In each case, a positional shift in conductive elements is representative of a strain experienced by the flexible substrate. The strain can be measured by measuring a property (e.g., a mm-wave property) of the mm-wave metamaterial array that is affected by the positional shift in conductive elements. This property can be one or more of the capacitive, inductive, or galvanic couplings described above. As a result, these couplings may be referred to as “strain-dependent couplings.” A change in the property of the mm-wave metamaterial array can affect and induce a change in a phase shift, an amplitude shift, and/or a polarization shift of an electromagnetic wave (e.g., a mm-wave) that has interacted with the mm-wave metamaterial array. Measuring the change in property allows the sensor system to measure the strain, which can be extrapolated into a force measurement or an environmental condition measurement by a processor.

FIG. 3 illustrates a deformation principle according to one or more embodiments. On the left of FIG. 3, two elementary structures 301 and 302 are mechanically coupled to a flexible substrate 303. The conductive elements of the elementary structures 301 and 302 are mutually coupled by at least one stress strain-dependent coupling that changes based on the deformation of the flexible substrate 303. As the flexible substrate 303 is stretched in opposing directions along the y-axis (e.g., due to opposing forces), the two elementary structures 301 and 302 shift closer together as a result of the deformation to the flexible substrate 303, thereby changing a property of one or more strain-dependent couplings. It is noted that the geometric shape of the elementary structures 301 and 302 remains substantially unchanged due to the difference in the Young's modulate of the flexible substrate 303 and the elementary structures 301 and 302. In other words, the deformation is translated to the flexible substrate 303 but not to the elementary structures 301 and 302.

On the right of FIG. 3, the flexible substrate 303 is stretched in opposing directions along the x-axis (e.g., due to opposing forces). In this case, the two elementary structures 301 and 302 shift further apart as a result of the deformation to the flexible substrate 303, thereby changing a property of one or more strain-dependent couplings. Accordingly, the flexible substrate 303 can deform in different ways that cause positional shifts between elementary structures of a mm-wave metamaterial array that can be measured to determine a strain resulting from at least one force applied to the flexible substrate 303 or an environmental condition to which the flexible substrate 303 is exposed.

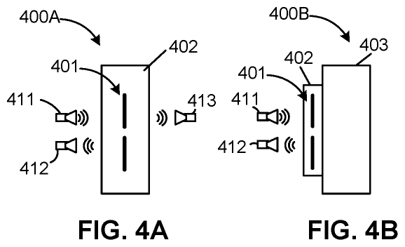

FIGS. 4A and 4B illustrate strain sensor systems 400A and 400B according to one or more embodiments. One or multiple metamaterial layers 401 are provided that include arrays of elementary structures that are arranged in periodic or aperiodic arrangements. The overall metamaterial has characteristic reflection spectra based on the characteristic resonant behavior of the elementary structures. These characteristic resonances strongly depend on shape and geometry of the elementary structures, as well as the position of the elementary structures relative to each other. Thus, the characteristic resonance is highly sensitive to small positional shifts of the elementary structures relative to each other. As a result, the reflective or transmissive behavior of the overall metamaterial component depends on the positional relationships of the elementary structures and is tuned or changed by positional shifts between the elementary structures. This change in reflection or transmission of incident electromagnetic waves is measured using mm-wave technology.

This measurement is feasible by coupling one or more metamaterial layers 401 directly to a flexible substrate 402 that serves as the measurement object (i.e., the object to which a force or environmental condition is applied), as shown in FIG. 4A. The flexible substrate 402 may be, for example, a millimeter wave printed circuit board (PCB). A metamaterial layer may be, for example, a microstrip, a stripline, or a coplanar waveguide. Alternatively, as shown in FIG. 4B, the flexible substrate 402 may be mounted to the measurement object 403 (i.e., the object to which a force or environmental condition is applied). As the measurement object 403 is deformed, the deformation is transferred to the flexible substrate 402, which also deforms in a substantially similar manner with respect to the deformation of the measurement object 403.

The conductive elements of the one or more metamaterial layers 401 are mutually coupled by a strain-dependent coupling that changes based on the deformation of the flexible substrate 402. The strain-dependent coupling affects a mm-wave property of a metamaterial layer such that the mm-wave property changes based on at least one force applied to the flexible substrate 402 or an environmental condition to which the flexible substrate 402 is exposed.

The elementary structures may be made of a conductive material, such as copper, gold, or aluminum. A Young's modulus of copper is 110 GPa, of gold is 77 GPa, and of aluminum is 68 GPa. The range of Young's modulus used for the flexible substrate material is from 1 MPa to 10 GPa, depending on the application. Thus, a large difference in Young's Modulus between the material of the elementary structures and the flexible substrate material is used to ensure that a geometry of the elementary structures remains substantially unchanged during deformation of the flexible substrate 402. The strain sensor systems 400A and 400B each includes a transmitter 411 configured to transmit mm-waves and a receiver 412 or 413 configured to receive mm-waves. It is also contemplated that the transmitter 411 and receiver 412 be combined into a transceiver. In particular, the transmitter 411 includes a transmitter antenna configured to transmit a mm-wave beam (i.e., an electro-magnetic transmit signal) at metamaterial layer 401. The transmitter antenna may be further representative of multiple antennas or an antenna array, which each transmitter antenna being configured to transmit a respective transmit mm-wave. For example, different transmit antenna may transmit mm-waves of different frequencies, amplitudes, or polarizations. The transmitter antennas can be operated in parallel (simultaneously) or by time division multiplexing.

Receiver 412 is configured to receive a partially-reflected mm-wave (i.e., an electromagnetic receive wave) from the metamaterial layer 401 that is generated as a result of the transmitted mm-wave interacting with (i.e., being partially absorbed by and reflected by) the metamaterial layer 401 and perform a measurement thereon. On the other hand, the receiver 413 is configured to receive a partially transmitted mm-wave (i.e., an electromagnetic receive wave) as a result of the transmitted mm-wave interacting with (i.e., being partially absorbed by and transmitted through) the metamaterial layer 401 and perform a measurement thereon. A receiver 412 or 413 may also include multiple receive antenna and receive circuitry, each sensitive to a different frequency or polarization.

While both receivers 412 and 413 are shown, only one need be present for measuring a property of an electromagnetic receive wave. The property of the electromagnetic receive wave may be a phase shift of the electromagnetic receive wave relative to a phase of the electromagnetic transmit wave or an amplitude shift of the electromagnetic receive wave relative to an amplitude of the electromagnetic transmit wave. Accordingly, each of the receives 412 and 413 includes receiver circuity for measuring a phase or an amplitude of the electromagnetic receive wave. For example, the receiver circuitry may include a demodulator configured to demodulate an electromagnetic receive wave to generate a demodulated signal, and a processor configured to determine a strain resulting from at least one force applied to the flexible substrate 406 or an environmental condition to which the flexible substrate 402 is exposed based on a measurement of an electromagnetic receive wave. In particular, the processor may evaluate a property of the demodulated signal using at least one of phase analysis, amplitude analysis, or spectral analysis, and determine the strain based on the evaluated property.

Regardless of the configuration, it will be understood that at least one transmitter and at least one receiver is implemented for transmitting and detecting mm-wave beams. The transmitters and receivers may be electrically coupled to a system controller and/or a DSP.

It will also be appreciated that both receivers 412 and 413 may be utilized. For example, one receiver may be arranged for detecting and measuring a partially-reflected mm-wave from the metamaterial layer 401 and another receiver may be arranged for detecting and measuring a partially transmitted mm-wave that passes through the same metamaterial layer 401 or a different metamaterial layer 401. Accordingly, an electromagnetic transmit wave is converted into an electromagnetic receive wave by interacting with one or more metamaterial layers 401. The interaction may include a reflection, an absorption, a transmission, or a combination thereof. Each receiver antenna is coupled to receiver circuitry configured to demodulate a receive signal in order to determine a characteristic of the receive signal. A magnitude of a strain is then determined by the receiver circuit or a system controller utilizing a signal processor based on the determined characteristic. The magnitude of the strain is unique to the phase or the amplitude of the received wave relative to its transmitted counterpart.

Thus, a receiver circuit may receive and demodulate a receive signal, and evaluate an amplitude modulation and/or a phase modulation of the receive signal using amplitude analysis and/or phase analysis, respectively. For example, the receiver circuit may evaluate an amplitude variation or a phase shift of the received signal. The received circuit may then determine the strain resulting from a force applied to the flexible substrate 402 or the environmental condition to which the flexible substrate 402 is exposed based on the measurement. For example, the receiver circuit may refer to a look-up table provided in memory that stores strain magnitudes relative to a specific amplitude modulation or phase modulation.

Thus, either the amplitude or the phase of the received signal is analyzed with respect to the same property of the transmitted signal. The metamaterial is a passive structure, it cannot change the frequency of the signal. However, it can change its own resonance frequency or, better said, the locations of its poles and zeros, which can then influence the reflected or the transmitted signal and be detected in amplitude and phase or in real and imaginary part of the signal. Both combinations describe the possible influence completely. Analyzing the shift of a resonance or a pole or a zero may also be characterized over the frequency with a frequency sweep of the transmit signal, but requires a more complex evaluation circuitry.

As an example for determining an absolute strain for the flexible substrate 402, the transmitter 411 may transmit a continuous mm-wave as a carrier signal that has a constant frequency. Each metamaterial layer 401 receives the carrier signal and partially reflects or transmits the signal to receiver 412 or 413. The receivers 412 and 413 includes a receiver circuit that is configured to determine a phase and/or an amplitude of each received signal, and compare the determined phase and/or amplitude to the phase and/or amplitude of the carrier signal, respectively, to derive the absolute strain value as a strain measurement. A certain change in phase or amplitude relative to the carrier signal (i.e., a phase shift or an amplitude shift) can correspond to the absolute strain on the flexible substrate 402.

Such a strain sensor system has the following benefits: the sensitivity is increased since mutual inductances or capacitances are directly affected by the deformation of the flexible substrate 402. This allows to sense small deformations that are orders of magnitude smaller than the elementary structure size of the metamaterial arrays. Further, deformation of the conductive elements is negligible, which prevents the elementary structure from wearing out through deformation and, thus, extends the life of the system. Moreover, the elastic modulus of the overall metamaterial component is determined by the choice of the flexible substrate material. This allows one to adjust the stiffness of the sensing element to the corresponding sensor application such that the strain sensor system can be integrated across many sensor applications.

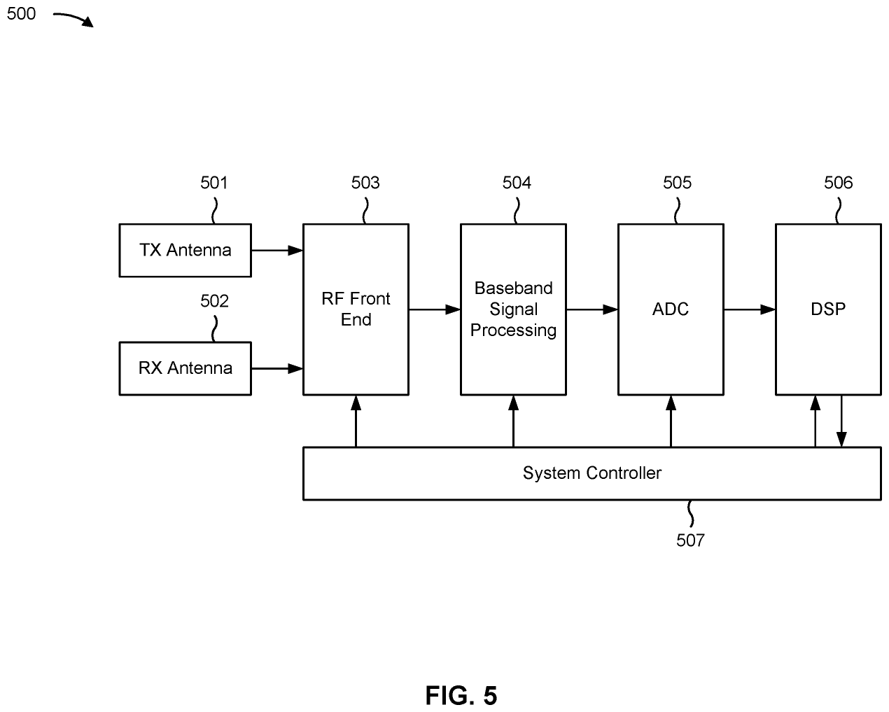

FIG. 5 is a block diagram that illustrates a transceiver circuit of a transceiver 500 according to one or more embodiments. The transceiver 500 is representative of any transmitter/receiver combination. The transceiver 500 includes relevant transmission circuitry and receiver circuitry to the embodiments described herein. It will also be appreciated that relevant transmission circuitry and receiver circuitry may be divided between a transmitter and a receiver according to implementation.

Frequency modulation may be used on the transmitter side to characterize the transfer function of the transmission channel including the metamaterial over frequency. However, a continuous carrier wave with a constant frequency may also be used.

On the measurement side (receiver side), it would still be magnitude (amplitude) and phase or I and Q, which would be the most sophisticated and flexible solution. However, with respect to cost, a system with a constant frequency carrier may be preferable. In this case, the frequency is chosen to be in a defined region with respect to the poles and zeros where the phase or amplitude transfer function has a monotonous behavior with respect to the modified property of the metamaterial. Then a local measurement of phase shift or amplitude attenuation is used.

Accordingly, at least one transmission antenna 501 (TX antenna configuration) and a receiver antenna 502 (RX antenna configuration) are connected to an RF front end 503 integrated into a chip, which front end may contain all those circuit components that are required for RF signal processing. These circuit components comprise for example a local oscillator (LO), RF power amplifiers, low noise amplifiers (LNA), directional couplers (for example rat-race couplers, circulators, etc.), and mixers for downmixing (or down-converting) the RF signals into baseband or an intermediate frequency band (IF band). The RF front end 503 may—possibly together with further circuit components—be integrated into a chip, which is usually referred to as a monolithic microwave integrated circuit (MMIC).

The example illustrated shows a bistatic (or pseudo-monostatic) radar system with separate RX and TX antennas. In the case of a monostatic radar system, a single antenna would be used both to emit and to receive the electromagnetic (radar) signals. In this case, a directional coupler (for example a circulator) may be used to separate the RF signals to be emitted from the received RF signals (radar echo signals). Radar systems in practice usually have a plurality of transmission and reception channels (TX/RX channels) with a plurality of TX and RX antennas, which makes it possible, inter alia, to measure the direction (DoA) from which the radar echoes are received. In such multiple-input multiple-output (MIMO) systems, the individual TX channels and RX channels in each case usually have an identical or similar structure.

In the case of a frequency modulated continuous wave (FMCW) radar system, the RF signals emitted by the TX antenna configuration 501 may be for example in the range of approximately 10 GHz to 1 THz. However, the frequency bands that are applied here depend on the structures to be used for the generation of the metamaterial target. As mentioned, the RF signal received by the RX antenna configuration 502 comprises the radar echoes (chirp echo signals), that is to say those signal components that are backscattered at one or at a plurality of radar targets. The received RF signal is downmixed for example into baseband (or an IF band) and processed further in baseband by way of analog signal processing (see analog baseband signal processing chain 504).

The analog baseband signal processing circuitry 504 essentially comprises filtering and possibly amplifying the baseband signal. The baseband signal is finally digitized (see analog-to-digital converter 505) and processed further in the digital domain. The digital signal processing chain may be implemented at least partly in the form of software that is able to be executed on a processor, for example a microcontroller, a digital signal processor (DSP) 506, or another computer unit.

The overall system is generally controlled by way of a system controller 507 that may likewise be implemented at least partly in the form of software that is able to be executed on a processor, such as for example a microcontroller. The RF front end 503 and the analog baseband signal processing chain 504 (optionally also the analog-to-digital converter 505) may be integrated together in a single MMIC (that is to say an RF semiconductor chip). As an alternative, the individual components may also be distributed over a plurality of integrated circuits.

The DSP 506 is configured to analyze a phase shift or an amplitude shift of one or more signals received from a metamaterial layer 401 to determine the strain on the flexible substrate 402. The DSP 506 is configured to perform the aforementioned phase analysis, amplitude analysis, and/or spectral analysis to determine the strain based on the determined amplitude modulation and/or phase modulation. The phase modulation of a received signal may be a phase shift of the received signal with respect to a phase of the transmitted mm-wave. Similarly, the amplitude modulation of a received signal may be an amplitude shift of the received signal with respect to an amplitude of the transmitted mm-wave. The DSP 506 may be configured to determine a phase shift and/or an amplitude shift of a received signal and translate the shift into a strain measurement resultant from an applied force or environmental condition. For example, the DSP 506 may refer to a look-up table provided in memory that stores strain values relative to a specific amplitude modulation and/or phase modulation.

In addition, the DSP 506 may receive signals from two different metamaterial layer 401, calculate a differential measurement value from the signals, and determine the strain based on the differential measurement value, for example, by using a look-up table in which differential measurement values are correlated to different strains. A further look-up table may be used to correlate a measured strain into an applied force, such as torque, or an environmental condition.

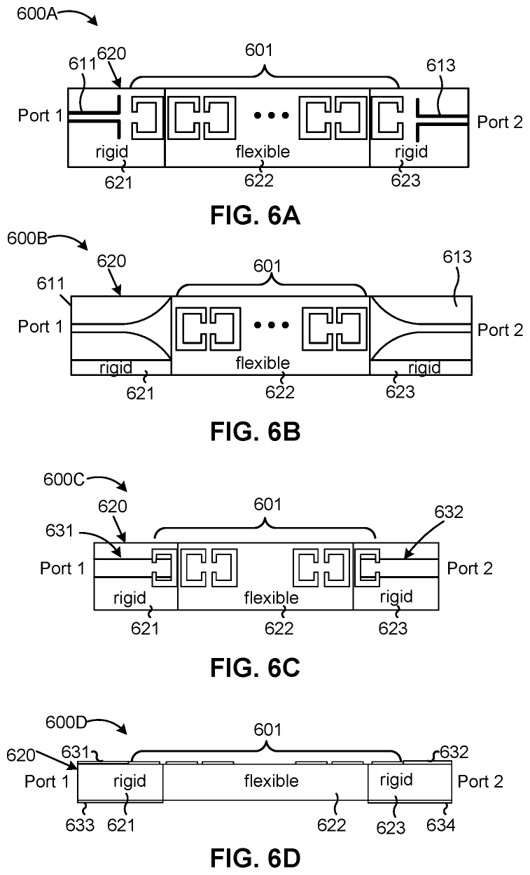

FIGS. 6A and 6B illustrate strain sensor systems 600A and 600B according to one or more embodiments. FIGS. 6C and 6D respectively illustrate top and side views of a strain sensor system 600C according to one or more embodiments.

In FIG. 6A, the strain sensor system 600A includes a metamaterial layer 601 of elementary structures mechanically coupled to a circuit substrate 620, such as a PCB. The circuit substrate 620 includes a first rigid substrate 621, a flexible substrate 622, and a second rigid substrate 623, with the flexible substrate 622 being interposed between the first and the second rigid substrates 621 and 623. The first rigid substrate 621, the flexible substrate 622, and the second rigid substrate 623, may be bonded together by adhesive or may be formed during lamination of the same sheet as a single integral construction, for example. The Young's Modulus of the flexible substrate 622 is higher than the Young's Modulus of the first rigid substrate 621 and the second rigid substrate 623 by, for example, at least a factor of 10,000. A deformation to the flexible substrate 622 causes positional shifts between the elementary structures of the metamaterial layer 601, which affects a mm-wave property of the metamaterial layer 601.

The first rigid substrate 621 includes a transmit antenna 611 that transmits an electromagnetic transmit wave (e.g., an mm-wave). The second rigid substrate 623 includes a receive antenna 613 that receives an electromagnetic receive wave converted from the electromagnetic transmit wave by the elementary structures of the metamaterial layer 601. The transmit antenna 611 and the receive antenna 613 are slot line fed dipole antennas.

The elementary structures are coplanar with the transmit antenna 611 and the receive antenna 613. Accordingly, the electromagnetic transmit wave travels through the elementary structures at it interacts therewith, and the elementary structures modify a property of the electromagnetic transmit wave based on their strain-dependent coupling. The receive antenna 613 provides the electromagnetic receive wave to receiver circuitry that performs processing thereon in a similar manner described above. Accordingly, the first rigid substrate 621 has an input port Port1 coupled to transmitter circuitry that generates an electromagnetic signal for transmission as the electromagnetic transmit wave and the second rigid substrate 623 has an output port Port2 coupled to receiver circuit for outputting a modified electromagnetic signal based on the electromagnetic receive wave. The strain sensor system 600B shown in FIG. 6B is similar to the strain sensor system 600A, with the exception that the transmit antenna 611 and the receive antenna 613 are coplanar Vivaldi antennas.

The strain sensor system 600C shown in FIGS. 6C and 6D is similar to the strain sensor system 600A, with the exception that the strain sensor system 600C uses coplanar waveguides 631 and 632 at the input and output ports, respectively, instead of antennas. In particular, the coplanar waveguide 631 directly couples an electromagnetic transmit wave into the metamaterial layer 601 and the coplanar waveguide 632 directly couples an electromagnetic receive wave out of the metamaterial layer 601.

In FIG. 6D, it can be seen that the transmission and reception means (i.e., the coplanar waveguides 631 and 632), as well as the elementary structures of the metamaterial layer 601, are arranged on the frontside of the circuit substrate 620. In addition, the rigid backings 633 and 634 may be applied to the backside of the first and second rigid substrates 621 and 623, respectively, to provide additional rigidity in those regions.

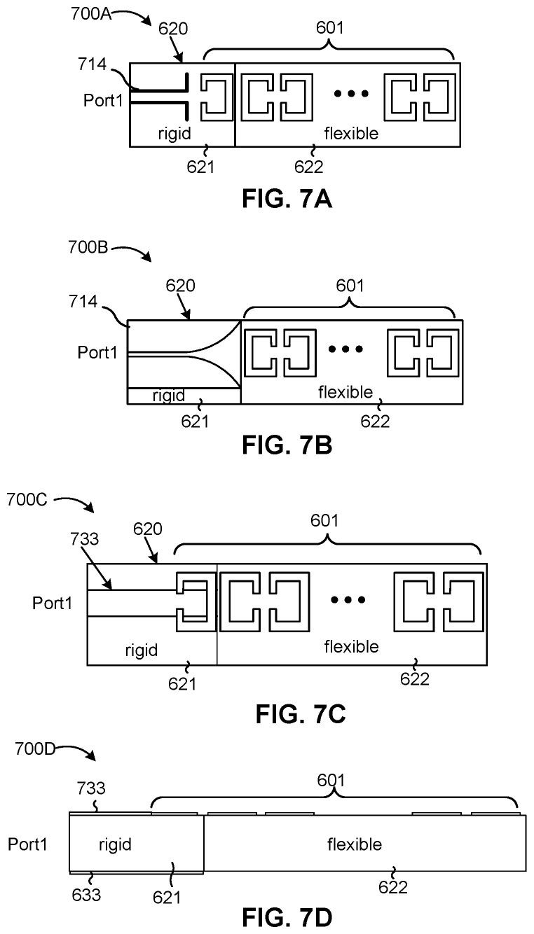

FIGS. 7A and 7B illustrate strain sensor systems 700A and 700B according to one or more embodiments. FIGS. 7C and 7D respectively illustrate top and side views of a strain sensor system 700C according to one or more embodiments.

The strain sensor system 700A shown in FIG. 7A is similar to the strain sensor system 600A, with the exception that the strain sensor system 700A includes a single input/output port Port1 (i.e., a transceiver port) for transmitting and receiving electromagnetic signals. Thus, the strain sensor system 700A includes a transceiver antenna 714 that transmits an electromagnetic transmit wave and subsequently receives an electromagnetic receive wave.

The electromagnetic transmit wave is reflected by the elementary structures, which modify a property of the electromagnetic transmit wave as it is partially reflected based on their strain-dependent couplings. The transceiver antenna 714 provides the electromagnetic receive wave to receiver circuitry that performs processing thereon in a similar manner described above.

The strain sensor system 700B shown in FIG. 7B is similar to the strain sensor system 600B, with the exception that the strain sensor system 700B includes a single input/output port Port1 (i.e., a transceiver port) for transmitting and receiving electromagnetic signals. Thus, the strain sensor system 700B includes a transceiver antenna 714 that transmits an electromagnetic transmit wave and subsequently receives an electromagnetic receive wave.

The electromagnetic transmit wave is reflected by the elementary structures, which modify a property of the electromagnetic transmit wave as it is partially reflected based on their strain-dependent coupling. The transceiver antenna 714 provides the electromagnetic receive wave to receiver circuitry that performs processing thereon in a similar manner described above.

The strain sensor system 700C shown in FIGS. 7C and 7D is similar to the strain sensor system 600C, with the exception that the strain sensor system 700C includes a single input/output port Port1 (i.e., a transceiver port) for transmitting and receiving electromagnetic signals. Thus, the strain sensor system 700C includes a transceiver coplanar waveguide 733 that transmits an electromagnetic transmit wave and subsequently receives an electromagnetic receive wave.

The electromagnetic transmit wave is reflected by the elementary structures, which modify a property of the electromagnetic transmit wave as it is partially reflected based on their strain-dependent couplings. The transceiver coplanar waveguide 733 provides the electromagnetic receive wave to receiver circuitry that performs processing thereon in a similar manner described above.

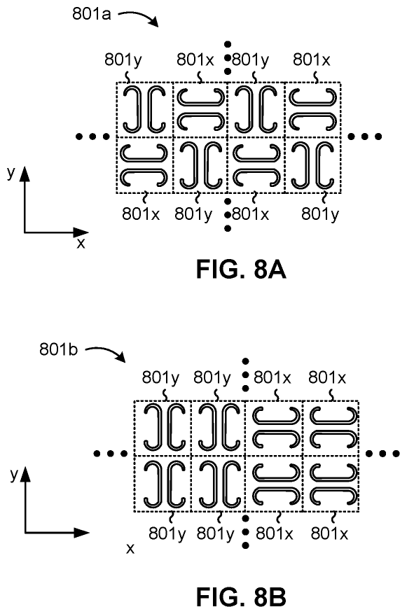

FIGS. 8A and 8B illustrate segments of common metamaterial layers 801a and 801b according to one or more embodiments. The common metamaterial layers 801a and 801b includes two mm-wave metamaterial arrays, with each mm-wave metamaterial array having elementary structures that have a different sensitivity axis. For example, the common metamaterial layer 801 includes elementary structures 801x and 801y having different orientations. In this example, the orientations are orthogonal to each other but is not limited thereto. In particular, elementary structures 801x are oriented in the x-direction according to an x-axis of symmetry and elementary structures 801y are oriented in the y-direction according to a y-axis of symmetry.

As a result of their orientations, the elementary structures 801x and 801y are sensitive to electromagnetic waves of different polarizations. The mm-wave metamaterial array formed by elementary structures 801x is sensitive to electromagnetic waves linearly polarized in the x-direction and is substantially insensitive to electromagnetic waves linearly polarized in the y-direction. In contrast, the mm-wave metamaterial array formed by elementary structures 801y is sensitive to electromagnetic waves linearly polarized in the y-direction and is substantially insensitive to electromagnetic waves linearly polarized in the x-direction. Therefore, it can be said that each of the elementary structures 801x of a first metamaterial array have a first sensitivity axis aligned with the x-direction and each of the elementary structures 801y of a second metamaterial array have a second sensitivity axis aligned with the y-direction.

The differently-oriented elementary structures may be formed in separate metamaterial layers that are combined into a common metamaterial layer or the separate metamaterial layers may be spatially separated from each other.

In the common metamaterial layer 801a, the differently-oriented elementary structures are intermixed with each other in the common metamaterial layer 801. In contrast, in the common metamaterial layer 801b, the differently-oriented elementary structures are separate from each other in the common metamaterial layer 801b, with one metamaterial array of elementary structures being formed next to by separate from the other metamaterial array of elementary structures. Therefore, the elementary structures 801x of the first array of elementary structures are intermixed with the elementary structures 801y of the second array of elementary structures within the common conductive layer 801a. In contrast, the elementary structures 801x of the first array of elementary structures would be mechanically coupled to a first region of a flexible substrate and the elementary structures 801y of the second array of elementary structures would be mechanically coupled to a second region of the flexible substrate, where the first region and the second region are mutually exclusive regions in the common metamaterial layer 801b.

Due to the anisotropy of the metamaterial elementary structures, the interaction with electromagnetic fields strongly depends on the polarization. In FIGS. 8A and 8B, electric fields oriented in y-direction do not couple with elementary structures 801x oriented in x-direction and electric fields oriented in x-direction do not couple with elementary structures 801y oriented in y-direction vice-versa. As a result, the deformation of the x- and y-oriented elementary structures can be measured independently with electromagnetic mm-waves, polarized perpendicularly to each other. This allows the receiver circuit to distinguish between two different directional strains and compensate for an overall expansion of the metamaterial that may be caused by thermal expansion of the flexible substrate.

For example, one of the above-described transmitters can be configured to transmit a first electromagnetic transmit wave towards the common metamaterial layer 801a, where the first electromagnetic transmit wave is linearly polarized in the x-direction. One of the above-described transmitters can be configured to transmit a second electromagnetic transmit wave towards the common metamaterial layer 801a, where the second electromagnetic transmit wave is linearly polarized in a direction that is non-parallel to the x-direction. In this example, the second electromagnetic transmit wave is linearly polarized in the y-direction.

The first and second electromagnetic transmit waves can be transmitted in simultaneously by two transmitters or sequentially via time-division multiplexing by one or more transmitters.

The elementary structures 801x are configured to convert the first electromagnetic transmit wave into a first electromagnetic receive wave based on their first strain-dependent coupling. The elementary structures 801y are configured to convert the second electromagnetic transmit wave into a second electromagnetic receive wave based on their second strain-dependent coupling.

One of the above-described receivers is configured to receive the first electromagnetic receive wave and acquire a first measurement of a first property of the first electromagnetic receive wave. One of the above-described receivers is configured to receive the second electromagnetic receive wave and acquire a second measurement of a second property of the second electromagnetic receive wave. The receiver circuitry is configured to determine a first strain resulting from the at least one force applied to the flexible substrate or the environmental condition to which the first flexible substrate is exposed based on the first measurement and also determine a second strain resulting from the at least one force applied to the flexible substrate or the environmental condition to which the flexible substrate is exposed based on the second measurement. The at least one force comprises a first force applied to the flexible substrate along the x-axis and a second force applied to the flexible substrate along the y-axis. The receiver circuitry independently determines the first strain based on the first measurement and the second strain based on the second measurement.

Further embodiments contemplate using layered composites of the above described deformable flexible substrate. Multiple metamaterial layers may for formed on and/or embedded in a flexible substrate or multiple flexible substrates can be stacked on one another, with each flexible substrate including one or more metamaterial layers. Elementary structures in different metamaterial layers may be coupled to each other by respective strain-dependent couplings. Thereby, each metamaterial layer includes a planar periodic array of the elementary structures. The idea is to have a larger volume of interaction between the incident electromagnetic waves and the resonant elementary structures of the metamaterial. Further, it is possible to implement a coupling between the planes of the metamaterial. For that case, the distance between metamaterial layers is of the same order of magnitude as the in-plane coupling distances. This inter-plane coupling is sensitive to changes in the separation distance between the planes of metamaterial layers and thus also sensitive to deformations of the bulk metamaterial. It is possible to combine the effects of tuning the in-plane and inter-plane coupling between the metamaterial elements.

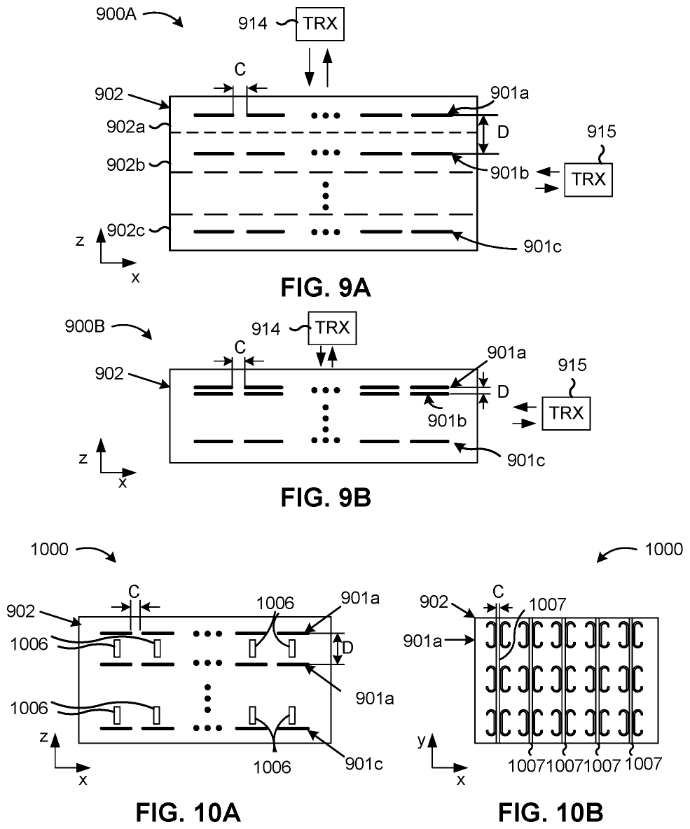

FIG. 9A is a side view of a strain sensing system 900A according to one or more embodiments. The strain sensing system 900A includes multiple metamaterial layers 901a, 901b, 901c arranged in the vertical direction (e.g., the z-direction) of a flexible substrate 902. The flexible substrate 902 may be a unitary substrate or may be composed of multiple flexible substrates 902a, 902b, . . . , and 902c stacked on one another.

Individual elementary structures of each metamaterial layers 901a, 901b, 901c are shown. The elementary structures within a same metamaterial layer have an in-plane strain-dependent coupling to each other that is dependent on a deformation in an in-plane direction (e.g., in the x-direction or the y-direction).

Additionally, elementary structures of neighboring metamaterial layers have an inter-plane strain-dependent coupling to each other that is dependent on a deformation in an inter-plane direction (e.g., in the z-direction). In this example, the elementary structures within a same metamaterial layer are separated by an in-plane coupling distance C that changes based on the deformation in an in-plane direction. The elementary structures in neighboring metamaterial layers are separated by an inter-plane coupling distance D that changes based on the deformation in the inter-plane direction. The inter-plane coupling distance D is significantly larger than the in-plane coupling distance C in FIG. 9A.

A transceiver 914 may transmit and receive mm-waves that are used to measure the inter-plane strain-dependent coupling between neighboring metamaterial layers. In can be said that metamaterial layer 901a is arranged in a first plane of the flexible substrate 902 and metamaterial layer 901b is arranged in a second plane of the flexible substrate 902, where the first plane and the second plane are arranged at different transmission distances from the transceiver 914. The metamaterial layer 901a and the metamaterial layer 901b, together, convert an electromagnetic transmit wave into an electromagnetic receive wave based on their inter-plane strain-dependent coupling. The transceiver 914 is configured to receive the electromagnetic receive wave and acquire a measurement of a property of the electromagnetic receive wave (e.g., an amplitude or phase measurement).

A transceiver 915 may transmit and receive mm-waves that are used to measure the in-plane strain-dependent coupling between elementary structures in a same metamaterial layer. For example, the elementary structures of metamaterial layer 901a convert an electromagnetic transmit wave into an electromagnetic receive wave based on their in-plane strain-dependent coupling. The transceiver 915 is configured to receive the electromagnetic receive wave and acquire a measurement of a property of the electromagnetic receive wave (e.g., an amplitude or phase measurement). In this way, strain measurements in both in-plane and inter-plane directions can be obtained.

FIG. 9B is a side view of a strain sensing system 900B according to one or more embodiments. Strain sensing system 900B is similar to strain sensing system 900A, with the exception that the inter-plane coupling distance D is of the same order of magnitude as the in-plane coupling distance C.

FIGS. 10A and 10B respectively illustrate side and top views of a strain sensing system 1000 according to one or more embodiments. Strain sensing system 1000 is similar to strain sensing system 900A, with the exception that strain sensing system 1000 further includes rigid struts 1006 and 1007 for modifying the stiffness of the overall flexible substrate 902 in different directions. In particular, rigid struts 1006 are arranged between conductive elements of different metamaterial layers to modify the stiffness in the inter-plane direction (e.g., the z-direction) and rigid struts 1007 are arranged between conductive elements of the same metamaterial layer to modify the stiffness in an in-plane direction (e.g., the x-direction). In this way, anisotropic elasticity can be achieved.

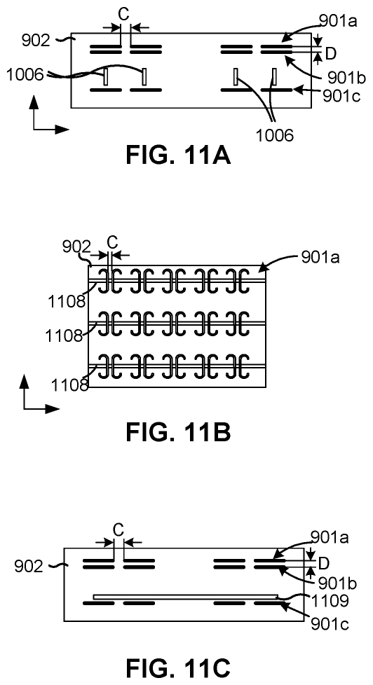

FIGS. 11A and 11B respectively illustrate side and top views of a strain sensing system 1100 according to one or more embodiments. Strain sensing system 1100 is similar to strain sensing system 1000, with the exception that strain sensing system 1100 further includes rigid struts 1008 instead of rigid struts 1007. The rigid struts 1008 are arranged between conductive elements of the same metamaterial layer to modify the stiffness in an in-plane direction (e.g., the y-direction).

FIG. 11C illustrates a side view of a strain sensing system 1100A according to one or more embodiments. The strain sensing system 1100A has an alternative configuration compared to the strain sensing system 1100 shown in FIG. 11A. Specifically, instead of small struts 1006 being dispersed across the flexible substrate 902, a single strut 1109 extends across the flexible substrate 902.

Metamaterial has a refractive index is dependent on the polarization of the incident electromagnetic waves and externally applied strain or deformation tunes the corresponding refractive indices. With metamaterial, it is possible to implement strain measurements analogous to the principle of photoelasticity and with a setup analogous to a reflective polariscope. The refractive indices of the metamaterials are determined by their resonant behavior and thus exceptionally sensitive to small deformations. Additional embodiments exploit the anisotropy of the resonant behavior with respect to the polarization of the incident electromagnetic waves.

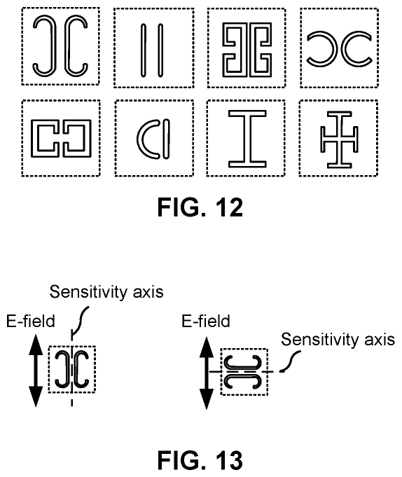

Metamaterial structures can be designed to have a strong anisotropy with respect to the polarization of the electromagnetic fields with which they interact, as similarly described above in reference to FIGS. 8A and 8B. FIG. 12 illustrates some example anisotropic metamaterial elementary structures according to one or more embodiments. FIG. 13 illustrates a principle of anisotropy with respect to anisotropic metamaterial elementary structures according to one or more embodiments. The underlaying concept is that these elementary structures have a characteristic resonant behavior when they interact with incident electromagnetic waves of a certain polarization. Due to their anisotropy, this resonant behavior is strongly dependent on the polarization of the electromagnetic field they interact with.

On the left side of FIG. 13, the electric field is parallel to the gap between conductive elements of the elementary structure. In other words, the electric field of an electromagnetic wave (e.g., an mm-wave) is parallel to the sensitivity axis of the elementary structure. In this case, the elementary structure exhibits a characteristic resonant behavior at a certain frequency f_{mmw}.

On the right side of FIG. 13, the electric field of an electromagnetic wave (e.g., an mm-wave) is perpendicular to the gap between conductive elements of the elementary structure. In other words, the electric field of the electromagnetic wave (e.g., an mm-wave) is perpendicular to the sensitivity axis of the elementary structure. In this case, the elementary structure does not show a resonant behavior to the electromagnetic wave at frequency f_{mmw}. Since the refractive index close to f_{mmw} is determined by the resonances, it has significantly different values for the polarization parallel and perpendicular to the gap. As a result, the metamaterial array with anisotropic metamaterial elementary structures is strongly birefringent. In other words, the metamaterial array with anisotropic metamaterial elementary structures is sensitive to a specific polarization of the electric field and a specific frequency or frequency band and is substantially insensitive to other polarization and/or frequencies outside of its target frequency or frequency band.

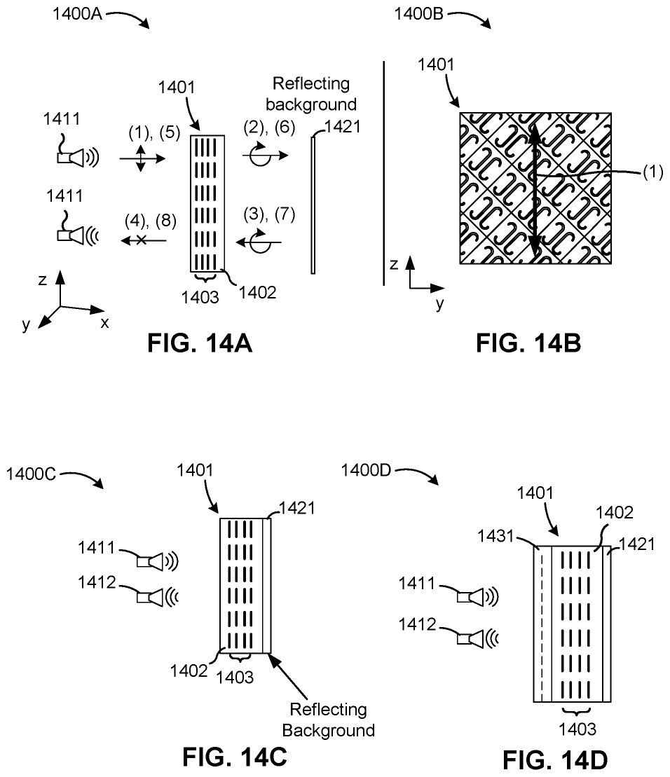

FIG. 14A illustrates a strain sensor system 1400A according to one or more embodiments. The strain sensor system 1400A includes a quarter waveplate 1401 that includes a flexible substrate 1402 configured to undergo a deformation in response to at least one force applied to the flexible substrate 1402 or an environmental condition to which the flexible substrate 1402 is exposed. The quarter waveplate 1401 also includes a metamaterial layer 1403 mechanically coupled to the flexible substrate 1402. The metamaterial layer 1402 comprises an array of elementary structures that are mutually coupled by a strain-dependent coupling that changes based on the deformation of the flexible substrate 1402. The elementary structures themselves are made of conductive elements and these conductive elements can also be said to be mutually coupled by a strain-dependent coupling that changes based on the deformation of the flexible substrate 1402. Accordingly, based on the strain-dependent coupling, the metamaterial layer 1403 converts a first polarized electromagnetic wave (1) having a first polarization into a second polarized electromagnetic wave (2) having a second polarization different from the first polarization.

The strain sensor system 1400A includes a transmitter 1411 that transmits the first polarized electromagnetic wave (1) having the first (linear) polarization. In this example, the first polarization is aligned vertically in the z-direction. As a result, the electric field of the first polarized electromagnetic wave (1) does not have a horizontal component. The strain sensor system 1400A further includes a receiver 1412 vertically polarized. In other words, the receiver 1412 is sensitive to vertical components an electric field and but is insensitive to horizontal components of the electric field. Thus, the receiver 1412 is configured to detect and measure electromagnetic waves that have an electric field with a vertical component.

The birefringence of the metamaterial layer 1403 depends on the strain or deformation of the flexible substrate 1402. The deformation of the flexible substrate 1402 changes the effect of the metamaterial layer 1403 on the polarization of the electromagnetic wave transmitted through the quarter waveplate 1401 as a function of strain. In particular, the deformation of the flexible substrate 1402 causes a positional shift of the conductive elements of the metamaterial layer 1403 relative to each other, thereby causing a change in the strain-dependent coupling of those conductive elements. This position shift occurs with substantially no deformation to the geometry of the conductive elements.

FIG. 14B illustrates front view of the quarter waveplate 1401. The axes of the elementary structures are oriented 45° relative to the first polarization of the first polarized electromagnetic wave (1). The metamaterial parameters are designed such that a phase shift or retardation between electromagnetic waves polarized in a horizontal direction and electromagnetic waves polarized in a vertical direction is λ/4 or an odd multiple thereof ((2n-1)·λ/4, with n being an integer). This is based on the different refractive indices for the two vertical and horizontal polarizations. This setup is irradiated by linearly polarized millimeter waves with the orientation of the linear polarization 45° relative to the elementary structures in-plane axes (e.g., the y- and z-axes). Due to the orientation of the elementary structures relative to the first polarization of the first polarized electromagnetic wave (1), the metamaterial layer 1403 converts the first polarized electromagnetic wave (1) into the second polarized electromagnetic wave (2) that has a circular polarization (e.g., a polarization in a clockwise direction).

Turning back to FIG. 14A, the strain sensor system 1400A further includes a reflective structure 1421 that reflects electromagnetic waves. The reflective structure 1421 receives and reflects the second polarized electromagnetic wave (2), thereby converting the second polarized electromagnetic wave (2) into a third polarized electromagnetic wave (3) having a third polarization. The third polarization may be opposite to the second polarization. In this case, the third polarization has a circular polarization opposite to the second polarization (e.g., a polarization in a counterclockwise direction).

The third polarized electromagnetic wave (3) is directed back to the quarter waveplate 1401 by the reflective structure 1421. The metamaterial layer 1403 converts the third polarized electromagnetic wave (3) into a fourth polarized electromagnetic wave (4) having a fourth (linear) polarization. In particular, based on the strain-dependent coupling between conductive elements of the metamaterial layer 1403, the metamaterial layer 1403 converts the third polarized electromagnetic wave (3) into the fourth polarized electromagnetic wave (4), where the fourth polarization is different from the first polarization. The difference between the first polarization and the fourth polarization changes based on the strain-dependent coupling, which is modified by any deformation in the flexible substrate 1402. When there is no deformation in the flexible substrate 1402, the fourth polarization of the fourth polarized electromagnetic wave (4) should be purely horizontal or perpendicular to the first polarization. In other words, the fourth polarization is a linear polarization that is perpendicular to the first (linear) polarization when no stress is applied to the flexible substrate 1402. In that case, the electric field of the fourth polarized electromagnetic does not include a vertical component. In contrast, when the flexible substrate is deformed, the fourth polarization of the fourth polarized electromagnetic wave (4) includes both horizontal and vertical components.

The receiver 1412 is configured to measure the amplitude or intensity of the fourth polarized electromagnetic wave (4) as a function of the deformation of the flexible substrate 1402. For the case of no deformation, the intensity of the fourth polarized electromagnetic wave (4) is minimal (ideally zero). When the flexible substrate 1402 is deformed, the retardation changes (≠λ/4) and the amplitude of the fourth polarized electromagnetic wave (4) increases as a function of deformation or strain. This is measured using a millimeter wave receiver.

The receiver 1412 determines a strain resulting from the at least one force applied to the flexible substrate 1402 or the environmental condition to which the flexible substrate 1402 is exposed based on a measurement of the amplitude or the intensity of the fourth polarized electromagnetic wave (4). Alternatively, the receiver 1412 may measure the fourth polarization and determine a strain resulting from the at least one force applied to the flexible substrate 1402 or the environmental condition to which the flexible substrate 1402 is exposed based on the measured fourth polarization. Alternatively, the receiver 1412 may measure an intensity of the fourth polarized electromagnetic wave (4) and determine a strain resulting from the at least one force applied to the flexible substrate 1402 or the environmental condition to which the flexible substrate 1402 is exposed based on the measured intensity, where the measured intensity is a function of the difference between the first polarization and the fourth polarization. The difference between the first polarization and the fourth polarization is a function of strain or deformation of the flexible substrate 1402.

The quarter waveplate 1401 may further include a second array of elementary structures that are mutually coupled by a second strain-dependent coupling that changes based on the deformation of the flexible substrate 1402. The flexible substrate 1402 may include two metamaterial layers. One metamaterial layer may have elementary structures with a first sensitivity direction and another metamaterial layer may have elementary structures with a different, second sensitivity direction, as similarly described in reference to FIGS. 8A and 8B. For example, the metamaterial layer 1403 may serve as a common metamaterial layer for two different arrays of elementary structures, as similarly described in reference to FIGS. 8A and 8B. Alternatively, the two metamaterial layers may be spatially separated in a depth direction of the flexible substrate 1402, as described in FIG. 9A. When no strain is applied, the retardation between vertical and horizontal polarizations is an odd multiple of λ/4. An applied strain then detunes the refractive index of both vertical and horizontal polarizations.

Accordingly, a first array of elementary structures that are mutually coupled by a first strain-dependent coupling that changes based on the deformation of the flexible substrate 1402 may convert the first polarized electromagnetic wave (1) having the first polarization into the second polarized electromagnetic wave (2) having the second polarization different from the first polarization and then convert the third polarized electromagnetic wave (3) into the fourth polarized electromagnetic wave (4) having the fourth (linear) polarization, as described above. The second array of elementary structures that are mutually coupled by a second strain-dependent coupling that changes based on the deformation of the flexible substrate 1402 may receive a fifth polarized electromagnetic wave (5) that is linearly polarized differently from the first polarized electromagnetic wave (1). In other words, the transmitter 1411 may be configured to transmit electromagnetic waves of different polarizations to target different arrays of elementary structures.

Specifically, the transmitter 1411 is configured to transmit a fifth polarized electromagnetic wave (5) having a fifth polarization at the second metamaterial layer. Based on the second strain-dependent coupling, the second metamaterial layer is configured to convert the fifth polarized electromagnetic wave (5) into a sixth polarized electromagnetic wave (6) having a sixth polarization (e.g., a clockwise polarization). The reflective structure 1421 receives and reflects the sixth polarized electromagnetic wave (6), thereby converting the sixth polarized electromagnetic wave (6) into a seventh polarized electromagnetic wave (7) having a seventh polarization (e.g., a counterclockwise polarization). Based on the second strain-dependent coupling, the second metamaterial layer is configured to convert the seventh polarized electromagnetic wave (7) into an eighth polarized electromagnetic wave (8) having an eighth (linear) polarization, where the eighth polarization is different from the fifth polarization and a difference between the fifth polarization and the eighth polarization changes based on the second strain-dependent coupling which changes based on the deformation of the flexible substrate 1402.

The receiver 1412 receives the eighth polarized electromagnetic wave (8), acquires an amplitude or intensity measurement of the eighth polarized electromagnetic wave (8), and determines a strain resulting from the at least one force applied to the flexible substrate 1402 or the environmental condition to which the flexible substrate 1402 is exposed based on the amplitude or intensity measurement.

FIG. 14C illustrates a strain sensor system 1400C according to one or more embodiments. The strain sensor system 1400C is similar to strain sensor system 1400A, with the exception that the waveplate 1401 and the reflective structure 1421 are coupled together.

FIG. 14D illustrates a strain sensor system 1400D according to one or more embodiments. The strain sensor system 1400D is similar to strain sensor system 1400C, with the exception that the waveplate 1401 further includes a linearly polarizing layer 1431 arranged on the frontside of the waveplate 1401. The linearly polarizing layer 1431 polarizes electromagnetic waves into a predetermined linear polarization.

Accordingly, the transmitter 1411 transmits an electromagnetic transmit wave and the linearly polarizing layer 1431 convert the electromagnetic transmit wave into a first polarized electromagnetic wave having a first polarization corresponding to the predetermined linear polarization. For example, the linearly polarizing layer 1431 may output a vertically polarized electromagnetic wave, similar to the first polarized electromagnetic wave (1) described above. Based on the strain-dependent coupling between the elementary structures of the metamaterial layer 1403, the metamaterial layer 1403 converts the first polarized electromagnetic wave into a second polarized electromagnetic wave having a second polarization (e.g., a clockwise polarization). The reflective structure 1421 receives and reflects the second polarized electromagnetic wave, thereby converting the second polarized electromagnetic wave into a third polarized electromagnetic wave having a third polarization (e.g., a counterclockwise polarization). Based on the strain-dependent coupling between the elementary structures of the metamaterial layer 1403, the metamaterial layer 1403 converts the third polarized electromagnetic wave into a fourth polarized electromagnetic wave having a fourth (linear) polarization, where the fourth polarization is different from the first polarization and a difference between the first polarization and the fourth polarization changes based on the strain-dependent coupling.

The fourth polarized electromagnetic wave is passed through the linearly polarizing layer 1431. If there is no deformation to the flexible substrate 1402, the fourth polarized electromagnetic wave may be linearly polarized 90° with respect to the first polarization. For example, the fourth polarized electromagnetic wave could be purely polarized in the horizontal direction in the absence of any deformation to the flexible substrate 1402. In this case, the linearly polarizing layer 1431, being vertically polarizing, entirely or substantially filters out the fourth polarized electromagnetic wave in such a way that the receiver 1412 receives zero or substantially zero intensity of the fourth polarized electromagnetic wave. In this case, any measurement taken by the receiver 1412 would be zero (not observable) or substantially zero.

However, if deformation is present at the flexible substrate 1402, the fourth polarized electromagnetic wave will have a component (e.g., a vertical component) that passes through the linearly polarizing layer 1431. In this case, the receiver 1412 receives at least a portion of the fourth polarized electromagnetic wave that passes through the linearly polarizing layer 1431, acquires an amplitude or intensity measurement of the fourth polarized electromagnetic wave, and determines a strain resulting from the at least one force applied to the flexible substrate 1402 or the environmental condition to which the flexible substrate 1402 is exposed based on the measurement.

It is noted that one or both the reflective structure 1421 and the linearly polarizing layer 1431 can be realized by mm-wave metamaterial.

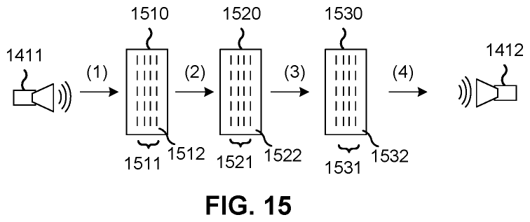

FIG. 15 illustrates a strain sensor system 1500 according to one or more embodiments. The strain sensor system 1500 is similar to strain sensor system 1400A, with exception that three waveplates 1510, 1520, and 1530 are used instead of relying on a reflective structure. Each of the three waveplates 1510, 1520, and 1530 includes a respective metamaterial layer 1511, 1521, 1531 coupled to a respective substrate 1512, 1522, 1532. One of the substrates 1512, 1522, 1532 may be a flexible substrate at which deformation is to be measured, while the other substrates may be rigid substrates that undergo no deformation or substantially no deformation (e.g., a substantially undetectable amount of deformation).

The transmitter 1411 transmits a first polarized electromagnetic wave (1) having a first (linear) polarization at the metamaterial layer 1511. The metamaterial layer 1511 converts the first polarized electromagnetic wave (1) into a second polarized electromagnetic wave having a second polarization different from the first polarization. For example, the second polarization may be a circular polarization (e.g., clockwise polarization). The metamaterial layer 1521 converts the second polarized electromagnetic wave (2) into a third polarized electromagnetic wave (3) having a third polarization (e.g., a counterclockwise polarization). The metamaterial layer 1531 converts the third polarized electromagnetic wave (3) into a fourth polarized electromagnetic wave (4) having a fourth (linear) polarization, where the fourth polarization is different from the first polarization and a difference between the first polarization and the fourth polarization changes based on a strain-dependent coupling of the metamaterial layer that is arranged on the flexible substrate. The receiver 412 receives the fourth polarized electromagnetic wave (4) and acquires an amplitude or intensity measurement of the fourth polarized electromagnetic wave to determine a deformation or strain of the flexible substrate.

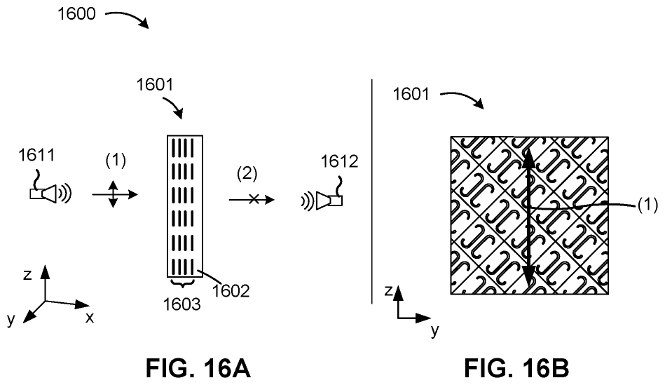

FIG. 16A illustrates a strain sensor system 1600 according to one or more embodiments. The strain sensor system 1600 includes a half waveplate 1601 that includes a flexible substrate 1602 configured to undergo a deformation in response to at least one force applied to the flexible substrate 1602 or an environmental condition to which the flexible substrate 1602 is exposed. The half waveplate 1601 also includes a metamaterial layer 1603 mechanically coupled to the flexible substrate 1602. The metamaterial layer 1602 comprises an array of elementary structures that are mutually coupled by a strain-dependent coupling that changes based on the deformation of the flexible substrate 1602. The elementary structures themselves are made of conductive elements and these conductive elements can also be said to be mutually coupled by a strain-dependent coupling that changes based on the deformation of the flexible substrate 1602. Accordingly, based on the strain-dependent coupling, the metamaterial layer 1603 converts a first polarized electromagnetic wave (1) having a first linear polarization into a second polarized electromagnetic wave (2) having a second linear polarization different from the first linear polarization.

The metamaterial layer 1603 is designed to imply a phase shift of an odd multiple of λ/2. When no strain is applied to the flexible substrate 1602, the first polarized electromagnetic wave (1), shown as being vertically polarized, is rotated by 90° to a horizontal polarization to generate the second polarized electromagnetic wave (2). The receiver 1612 is vertically polarized. That is, it is configured to detect vertical components of an electric field of an electromagnetic wave. Thus, when no strain is applied to the flexible substrate 1602, the receiver 1612 measures an amplitude or intensity of zero of the second polarized electromagnetic wave (2).

In contrast, when the flexible substrate 1602 is deformed, the rotation angle of the second linear polarization differs from 90° and part of the second polarized electromagnetic wave (2) is vertically polarized. As a consequent, the second polarized electromagnetic wave (2) detected at the receiver 1612. By measuring the amplitude or intensity of the second polarized electromagnetic wave (2), the strain or deformation can be determined by the receiver 1612. The larger the difference between the first and second polarizations (i.e., the closer the difference is to 90°), the smaller the strain or deformation and the smaller the amplitude or intensity of the second polarized electromagnetic wave (2). The smaller the difference between the first and second polarizations (i.e., the closer the difference is to 0°), the larger the strain or deformation and the larger the amplitude or intensity of the second polarized electromagnetic wave (2). Thus, the difference between the first polarization and the second polarization changes based on the strain-dependent coupling. The measured intensity is a function of the difference between the first polarization and the second polarization. The receiver 1612 may measure the second polarization and determine the strain based on the measured second polarization.

Polarization of the incident transmitted waves is either done directly at the transmitter or with additional polarizing layers on top and on back of the flexible substrate 1602.

FIG. 16B illustrates front view of the half waveplate 1601. The axes of the elementary structures are oriented 90° relative to the first polarization of the first polarized electromagnetic wave (1). The metamaterial parameters are designed such that a phase shift or retardation between electromagnetic waves polarized in a horizontal direction and electromagnetic waves polarized in a vertical direction is λ/2 or an odd multiple thereof ((2n-1)·λ/2, with n being an integer). Due to the orientation of the elementary structures relative to the first polarization of the first polarized electromagnetic wave (1), the metamaterial layer 1403 converts the first polarized electromagnetic wave (1) into the second polarized electromagnetic wave (2) that has a linear polarization rotated about the x-axis from the first polarization (i.e., rotated in the y-z plane).

The embodiments described herein can be used in all fields in which strain gauges are used. Furthermore, the embodiments provide the realization of a telemetric strain gauge.

One or more embodiments may be used for torque measurement on a rotating shaft. The sensor concept is robust against electromagnetic interferences. The metamaterial target is purely passive. The metamaterial component is also fabricable on substrates that withstand the large temperature range in automotive applications.

The sensor concept can also be applied in torque transducers for applications in test benches.

The sensor concept can also be applied to measure deformation or strain on wings or a fuselage, which is particularly important for wear-out detection, to measure force on wings or the fuselage, or to measure strain on junctions between wings and the fuselage.

The sensor concept can also be applied to measure the force on arbitrary components like wings, cantilever arms, rods, and other cantilever structures.

The sensor concept can also be applied to measure the force in engine mounts.

The sensor concept can also be applied to wear out detection on mechanical parts.

The high scalability of the sensor concept allows the implementation of strain and deformation measurement on bridges or buildings, and may provide information on structural stability. Telemetric readout allows uncomplicated measurement on specific components which potentially avoids the need for bridge or building closures during measurement.

The sensor concept can also be applied to robotics and cobots, particularly to torque and force measurements in robotics and cobots. The high scalability of the sensor concept allows to address implementations in miniaturized robotic components.

The sensor concept can also be applied to wind turbines to measure torque, force, and vibrations on the rotor blades of wind turbines.

The sensor concept can also be applied directly to pedals of bicycles to measure the applied force in real-time and thus provide precise information on torque and power for cyclists. Advantages are better scalability thus easier installation and lower power consumption. The sensor concept is suitable for force or torque measurement in pedelecs that is required for pedal force-based engine control. Both pedal force measurement or torque measurement at the bottom bracket are possible.

The sensor concept can also be applied to flywheels in high efficiency energy storage systems that are usually are vacuum sealed. Monitoring their deformation is crucial for wear out detection. Telemetric strain measurement is mandatory in that case. Strain gauges are difficult to implement since they require additional elaborate power supply. The sensor concept described herein provides telemetric read-out with, in principle, no restrictions to the distance between antennas and the metamaterial target. Furthermore, metamaterials can be manufactured on carbon fiber components, which has the potential for application in flywheels rotating at high speed.

The following provides an overview of some Aspects of the present disclosure:

Aspect 1: A sensor system, comprising: a first flexible substrate configured to undergo a deformation in response to at least one force applied to the first flexible substrate or an environmental condition to which the first flexible substrate is exposed; a first metamaterial layer mechanically coupled to the first flexible substrate, wherein the first metamaterial layer comprises a first array of conductive elements that are mutually coupled by a first strain-dependent coupling that changes based on the deformation of the first flexible substrate; at least one transmitter configured to transmit a first electromagnetic transmit wave towards the first metamaterial layer, wherein the first metamaterial layer is configured to convert the first electromagnetic transmit wave into a first electromagnetic receive wave based on the first strain-dependent coupling; and at least one receiver configured to receive the first electromagnetic receive wave and acquire a first measurement of a first property of the first electromagnetic receive wave.

Aspect 2: The sensor system of Aspect 1, wherein the at least one receiver is configured to determine a strain resulting from the at least one force applied to the first flexible substrate or the environmental condition to which the first flexible substrate is exposed based on the first measurement.

Aspect 3: The sensor system of any of Aspects 1-2, wherein the first strain-dependent coupling includes at least one of capacitive coupling, inductive coupling, or galvanic coupling.

Aspect 4: The sensor system of any of Aspects 1-3, wherein the first property of the first electromagnetic receive wave is a phase shift of the first electromagnetic receive wave relative to a phase of the first electromagnetic transmit wave or an amplitude shift of the first electromagnetic receive wave relative to an amplitude of the first electromagnetic transmit wave.

Aspect 5: The sensor system of any of Aspects 1-4, wherein the first strain-dependent coupling affects a millimeter (mm)-wave property of the first metamaterial layer such that the mm-wave property changes based on the at least one force applied to the first flexible substrate or the environmental condition to which the first flexible substrate is exposed.

Aspect 6: The sensor system of any of Aspects 1-5, further comprising: at least one processor configured to determine a strain resulting from the at least one force applied to the first flexible substrate or the environmental condition to which the first flexible substrate is exposed based on the first electromagnetic receive wave, wherein the at least one receiver is configured to demodulate the first electromagnetic receive wave to generate a demodulated signal, and wherein the at least one processor is configured to evaluate the first property of the demodulated signal using at least one of phase analysis, amplitude analysis, or spectral analysis, and determine the strain based on the evaluated first property. wherein the at least one receiver is configured to demodulate the first electromagnetic receive wave to generate a demodulated signal, and wherein the at least one processor is configured to evaluate the first property of the demodulated signal using at least one of phase analysis, amplitude analysis, or spectral analysis, and determine the strain based on the evaluated first property.

Aspect 7: The sensor system of any of Aspects 1-6, wherein the deformation of the first flexible substrate causes a positional shift of the conductive elements of the first array of conductive elements relative to each other, thereby causing a change in the first strain-dependent coupling.

Aspect 8: The sensor system of Aspect 7, wherein the deformation of the first flexible substrate causes the positional shift of the conductive elements of the first array of conductive elements relative to each other without deforming a geometry of the conductive elements of the first array of conductive elements.

Aspect 9: The sensor system of any of Aspects 1-8, wherein: the conductive elements of the first array of conductive elements have a first Young's Modulus and the first flexible substrate has a second Young's Modulus that is greater than the first Young's Modulus by a factor of at least 10,000.

Aspect 10: The sensor system of Aspect 9, wherein the deformation of the first flexible substrate causes the positional shift of the conductive elements of the first array of conductive elements relative to each while a geometry of the conductive elements of the first array of conductive elements remains substantially unchanged based on a difference between the first Young's Modulus and the second Young's Modulus.

Aspect 11: The sensor system of any of Aspects 1-10, further comprising: a circuit substrate comprising a first rigid substrate, a second rigid substrate, and the first flexible substrate interposed between the first rigid substrate and the second rigid substrate, wherein the first rigid substrate includes a transmit antenna configured to transmit the first electromagnetic transmit wave, and wherein the second rigid substrate includes a receive antenna configured to receive the first electromagnetic receive wave. wherein the first rigid substrate includes a transmit antenna configured to transmit the first electromagnetic transmit wave, and wherein the second rigid substrate includes a receive antenna configured to receive the first electromagnetic receive wave.

Aspect 12: The sensor system of any of Aspects 1-11, further comprising: a circuit substrate comprising a first rigid substrate, a second rigid substrate, and the first flexible substrate interposed between the first rigid substrate and the second rigid substrate, wherein the first rigid substrate includes a transceiver antenna configured to transmit the first electromagnetic transmit wave and receive the first electromagnetic receive wave, and wherein the first rigid substrate includes a transceiver antenna configured to transmit the first electromagnetic transmit wave and receive the first electromagnetic receive wave, and the second rigid substrate includes a reflecting structure configured to reflect an electromagnetic wave received from the first metamaterial layer back through the first metamaterial layer to the transceiver antenna.

Aspect 13: The sensor system of any of Aspects 1-12, further comprising: a circuit substrate comprising a first rigid substrate, a second rigid substrate, and the first flexible substrate interposed between the first rigid substrate and the second rigid substrate, wherein the first rigid substrate includes a first coplanar waveguide configured to couple the first electromagnetic transmit wave into the first metamaterial layer, and wherein the second rigid substrate includes a second coplanar waveguide configured to couple out the first electromagnetic receive wave from the first metamaterial layer. wherein the first rigid substrate includes a first coplanar waveguide configured to couple the first electromagnetic transmit wave into the first metamaterial layer, and wherein the second rigid substrate includes a second coplanar waveguide configured to couple out the first electromagnetic receive wave from the first metamaterial layer.

Aspect 14: The sensor system of any of Aspects 1-13, further comprising: a second metamaterial layer mechanically coupled to the first flexible substrate, wherein the second metamaterial layer comprises a second array of conductive elements that are mutually coupled by a second strain-dependent coupling that changes based on the deformation of the first flexible substrate, wherein the at least one transmitter is configured to transmit a second electromagnetic transmit wave at the second metamaterial layer, wherein the second metamaterial layer is configured to convert the second electromagnetic transmit wave into a second electromagnetic receive wave based on the second strain-dependent coupling, and wherein the at least one receiver is configured to receive the second electromagnetic receive wave and acquire a second measurement of a second property of the second electromagnetic receive wave. wherein the at least one transmitter is configured to transmit a second electromagnetic transmit wave at the second metamaterial layer, wherein the second metamaterial layer is configured to convert the second electromagnetic transmit wave into a second electromagnetic receive wave based on the second strain-dependent coupling, and wherein the at least one receiver is configured to receive the second electromagnetic receive wave and acquire a second measurement of a second property of the second electromagnetic receive wave.

Aspect 15: The sensor system of Aspect 14, wherein the at least one receiver is configured to determine a strain resulting from the at least one force applied to the first flexible substrate or the environmental condition to which the first flexible substrate is exposed based on the second measurement.

Aspect 16: The sensor system of Aspect 14, wherein: the at least one force comprises a first force applied to the first flexible substrate along a first axis and a second force applied to the first flexible substrate along a second axis perpendicular to the first axis, and the at least one receiver is configured to determine a first strain based on the first measurement and determine a second strain based on the second measurement.

Aspect 17: The sensor system of Aspect 14, wherein the first electromagnetic transmit wave is linearly polarized in a first direction and the second electromagnetic transmit wave is linearly polarized in a second direction that is non-parallel to the first direction.

Aspect 18: The sensor system of Aspect 17, wherein: the first metamaterial layer is sensitive to electromagnetic waves linearly polarized in the first direction and is substantially insensitive to electromagnetic waves linearly polarized in the second direction, and the second metamaterial layer is sensitive to electromagnetic waves linearly polarized in the second direction and is substantially insensitive to electromagnetic waves linearly polarized in the first direction.

Aspect 19: The sensor system of Aspect 17, wherein each of the conductive elements of the first array of conductive elements have a first sensitivity axis aligned with the first direction and each of the conductive elements of the second array of conductive elements have a second sensitivity axis aligned with the second direction.

Aspect 20: The sensor system of Aspect 14, wherein the first metamaterial layer and the second metamaterial layer are formed in a common conductive layer that is mechanically coupled to the first flexible substrate.

Aspect 21: The sensor system of Aspect 20, wherein: the conductive elements of the first array of conductive elements are intermixed with the conductive elements of the second array of conductive elements within the common conductive layer, or the conductive elements of the first array of conductive elements are mechanically coupled to a first region of the first flexible substrate and the conductive elements of the second array of conductive elements are mechanically coupled to a second region of the first flexible substrate, wherein the first region and the second region are mutually exclusive regions.

Aspect 22: The sensor system of any of Aspects 1-21, further comprising: a second metamaterial layer mechanically coupled to the first flexible substrate, wherein the second metamaterial layer comprises a second array of conductive elements that are mutually coupled to the first array of conductive elements by a second strain-dependent coupling that changes based on a separation distance between the first metamaterial layer and the second metamaterial layer, wherein the at least one transmitter is configured to transmit the first electromagnetic transmit wave at the first metamaterial layer and the second metamaterial layer, wherein the first metamaterial layer and the second metamaterial layer are configured to convert the first electromagnetic transmit wave into a second electromagnetic receive wave based on the second strain-dependent coupling, and wherein the at least one receiver is configured to receive the second electromagnetic receive wave and acquire a second measurement of a second property of the second electromagnetic receive wave. wherein the at least one transmitter is configured to transmit the first electromagnetic transmit wave at the first metamaterial layer and the second metamaterial layer, wherein the first metamaterial layer and the second metamaterial layer are configured to convert the first electromagnetic transmit wave into a second electromagnetic receive wave based on the second strain-dependent coupling, and wherein the at least one receiver is configured to receive the second electromagnetic receive wave and acquire a second measurement of a second property of the second electromagnetic receive wave.

Aspect 23: The sensor system of Aspect 22, wherein the at least one receiver is configured to determine a strain resulting from the at least one force applied to the first flexible substrate or the environmental condition to which the first flexible substrate is exposed based on the second measurement.

Aspect 24: The sensor system of Aspect 22, wherein the first metamaterial layer is arranged in a first plane of the first flexible substrate and the second metamaterial layer is arranged in a second plane of the first flexible substrate, wherein the first plane and the second plane are arranged at different transmission distances from the at least one transmitter.

Aspect 25: The sensor system of any of Aspects 1-24, further comprising: a second flexible substrate configured to undergo a deformation in response to the at least one force applied to the second flexible substrate or the environmental condition to which the second flexible substrate is exposed, wherein the first flexible substrate is stacked on the second flexible substrate; a second metamaterial layer mechanically coupled to the second flexible substrate, wherein the second metamaterial layer comprises a second array of conductive elements that are mutually coupled to the first array of conductive elements by a second strain-dependent coupling that changes based on a separation distance between the first metamaterial layer and the second metamaterial layer, wherein the at least one transmitter is configured to transmit a second electromagnetic transmit wave at the first metamaterial layer and the second metamaterial layer, wherein the first metamaterial layer and the second metamaterial layer are configured to convert the second electromagnetic transmit wave into a second electromagnetic receive wave based on the second strain-dependent coupling, and wherein the at least one receiver is configured to receive the second electromagnetic receive wave, acquire a second measurement of a second property of the second electromagnetic receive wave, and determine at least one strain measurement based on the first and the second measurements. wherein the at least one transmitter is configured to transmit a second electromagnetic transmit wave at the first metamaterial layer and the second metamaterial layer, wherein the first metamaterial layer and the second metamaterial layer are configured to convert the second electromagnetic transmit wave into a second electromagnetic receive wave based on the second strain-dependent coupling, and wherein the at least one receiver is configured to receive the second electromagnetic receive wave, acquire a second measurement of a second property of the second electromagnetic receive wave, and determine at least one strain measurement based on the first and the second measurements.

Aspect 26: The sensor system of any of Aspects 1-25, wherein the first electromagnetic transmit wave is a first polarized electromagnetic transmit wave having a first polarization and the first electromagnetic receive wave is a first polarized electromagnetic receive wave having a second polarization different from the first polarization, wherein the first metamaterial layer is configured to convert the first polarized electromagnetic transmit wave into the first polarized electromagnetic receive wave based on the first strain-dependent coupling, wherein a difference between the first polarization and the second polarization changes based on the first strain-dependent coupling, and wherein the at least one receiver is configured to determine a strain resulting from the at least one force applied to the first flexible substrate or the environmental condition to which the first flexible substrate is exposed based on the second polarization. wherein the first metamaterial layer is configured to convert the first polarized electromagnetic transmit wave into the first polarized electromagnetic receive wave based on the first strain-dependent coupling, wherein a difference between the first polarization and the second polarization changes based on the first strain-dependent coupling, and wherein the at least one receiver is configured to determine a strain resulting from the at least one force applied to the first flexible substrate or the environmental condition to which the first flexible substrate is exposed based on the second polarization.

Aspect 27: The sensor system of Aspect 26, wherein the at least one receiver is configured to measure the second polarization and determine the strain based on the measured second polarization.

Aspect 28: The sensor system of Aspect 26, wherein the at least one receiver is configured to measure an intensity of the first polarized electromagnetic receive wave and determine the strain based on the measured intensity, wherein the measured intensity is a function of the difference between the first polarization and the second polarization.

Aspect 29: A sensor system, comprising: a waveplate comprising: a first flexible substrate configured to undergo a deformation in response to at least one force applied to the first flexible substrate or an environmental condition to which the first flexible substrate is exposed; and a first metamaterial layer mechanically coupled to the first flexible substrate, wherein the first metamaterial layer comprises a first array of conductive elements that are mutually coupled by a first strain-dependent coupling that changes based on the deformation of the first flexible substrate, wherein, based on the first strain-dependent coupling, the first metamaterial layer is configured to convert a first polarized electromagnetic wave having a first polarization into a second polarized electromagnetic wave having a second polarization different from the first polarization.

Aspect 30: The sensor system of Aspect 29, further comprising: a reflective structure configured to reflect electromagnetic waves; a transmitter configured to transmit a first polarized electromagnetic wave having a first polarization at the first metamaterial layer, wherein the reflective structure is configured to receive and reflect the second polarized electromagnetic wave, thereby converting the second polarized electromagnetic wave into a third polarized electromagnetic wave having a third polarization, wherein, based on the first strain-dependent coupling, the first metamaterial layer is configured to convert the third polarized electromagnetic wave into a fourth polarized electromagnetic wave having a fourth polarization, wherein the fourth polarization is different from the first polarization and a difference between the first polarization and the fourth polarization changes based on the first strain-dependent coupling; and wherein the reflective structure is configured to receive and reflect the second polarized electromagnetic wave, thereby converting the second polarized electromagnetic wave into a third polarized electromagnetic wave having a third polarization, wherein, based on the first strain-dependent coupling, the first metamaterial layer is configured to convert the third polarized electromagnetic wave into a fourth polarized electromagnetic wave having a fourth polarization, wherein the fourth polarization is different from the first polarization and a difference between the first polarization and the fourth polarization changes based on the first strain-dependent coupling; and a receiver configured to receive the fourth polarized electromagnetic wave and acquire a first measurement of the fourth polarized electromagnetic wave.

Aspect 31: The sensor system of Aspect 30, wherein the receiver is configured to determine a strain resulting from the at least one force applied to the first flexible substrate or the environmental condition to which the first flexible substrate is exposed based on the first measurement

Aspect 32: The sensor system of Aspect 30, wherein the receiver is configured to measure the fourth polarization and determine a strain resulting from the at least one force applied to the first flexible substrate or the environmental condition to which the first flexible substrate is exposed based on the measured fourth polarization.

Aspect 33: The sensor system of Aspect 30, wherein the receiver is configured to measure an intensity of the fourth polarized electromagnetic wave and determine a strain resulting from the at least one force applied to the first flexible substrate or the environmental condition to which the first flexible substrate is exposed based on the measured intensity, wherein the measured intensity is a function of the difference between the first polarization and the fourth polarization.

Aspect 34: The sensor system of Aspect 30, wherein the first polarization is a first linear polarization, wherein the second polarization is a first circular polarization, wherein the third polarization is a second circular polarization opposite to the first circular polarization, and wherein the fourth polarization is a second linear polarization that is perpendicular to the first linear polarization when no stress is applied to the first flexible substrate.

Aspect 35: The sensor system of Aspect 30, further comprising: a second metamaterial layer mechanically coupled to the first flexible substrate, wherein the second metamaterial layer comprises a second array of conductive elements that are mutually coupled by a second strain-dependent coupling that changes based on the deformation of the first flexible substrate, wherein the transmitter is configured to transmit a fifth polarized electromagnetic wave having a fifth polarization at the second metamaterial layer, wherein, based on the second strain-dependent coupling, the second metamaterial layer is configured to convert the fifth polarized electromagnetic wave into a sixth polarized electromagnetic wave having a sixth polarization, wherein the reflective structure is configured to receive and reflect the sixth polarized electromagnetic wave, thereby converting the sixth polarized electromagnetic wave into a seventh polarized electromagnetic wave having a seventh polarization, wherein, based on the second strain-dependent coupling, the second metamaterial layer is configured to convert the seventh polarized electromagnetic wave into an eighth polarized electromagnetic wave having an eighth polarization, wherein the eighth polarization is different from the fifth polarization and a difference between the fifth polarization and the eighth polarization changes based on the second strain-dependent coupling, and wherein the receiver is configured to receive the eighth polarized electromagnetic wave, acquire a second measurement of the eighth polarized electromagnetic wave, and determine a strain resulting from the at least one force applied to the first flexible substrate or the environmental condition to which the first flexible substrate is exposed based on the second measurement. wherein the transmitter is configured to transmit a fifth polarized electromagnetic wave having a fifth polarization at the second metamaterial layer, wherein, based on the second strain-dependent coupling, the second metamaterial layer is configured to convert the fifth polarized electromagnetic wave into a sixth polarized electromagnetic wave having a sixth polarization, wherein the reflective structure is configured to receive and reflect the sixth polarized electromagnetic wave, thereby converting the sixth polarized electromagnetic wave into a seventh polarized electromagnetic wave having a seventh polarization, wherein, based on the second strain-dependent coupling, the second metamaterial layer is configured to convert the seventh polarized electromagnetic wave into an eighth polarized electromagnetic wave having an eighth polarization, wherein the eighth polarization is different from the fifth polarization and a difference between the fifth polarization and the eighth polarization changes based on the second strain-dependent coupling, and wherein the receiver is configured to receive the eighth polarized electromagnetic wave, acquire a second measurement of the eighth polarized electromagnetic wave, and determine a strain resulting from the at least one force applied to the first flexible substrate or the environmental condition to which the first flexible substrate is exposed based on the second measurement.

Aspect 36: A sensor system, comprising: a waveplate comprising: a first flexible substrate configured to undergo a deformation in response to at least one force applied to the first flexible substrate or an environmental condition to which the first flexible substrate is exposed; a first metamaterial layer mechanically coupled to the first flexible substrate, wherein the first metamaterial layer comprises a first array of conductive elements that are mutually coupled by a first strain-dependent coupling that changes based on the deformation of the first flexible substrate, wherein the first strain-dependent coupling includes at least one of capacitive coupling or inductive coupling; and a linearly polarizing layer configured to polarize electromagnetic waves into a predetermined linear polarization; and a reflective structure configured to reflect electromagnetic waves; a transmitter configured to transmit an electromagnetic transmit wave, wherein the linearly polarizing layer is configured to convert the electromagnetic transmit wave into a first polarized electromagnetic wave having a first polarization corresponding to the predetermined linear polarization, wherein, based on the first strain-dependent coupling, the first metamaterial layer is configured to convert the first polarized electromagnetic wave into a second polarized electromagnetic wave having a second polarization, wherein the reflective structure is configured to receive and reflect the second polarized electromagnetic wave, thereby converting the second polarized electromagnetic wave into a third polarized electromagnetic wave having a third polarization, wherein, based on the first strain-dependent coupling, the first metamaterial layer is configured to convert the third polarized electromagnetic wave into a fourth polarized electromagnetic wave having a fourth polarization, wherein the fourth polarization is different from the first polarization and a difference between the first polarization and the fourth polarization changes based on the first strain-dependent coupling; and a receiver configured to receive at least a portion of the fourth polarized electromagnetic wave, acquire a first measurement of the fourth polarized electromagnetic wave, and determine a strain resulting from the at least one force applied to the first flexible substrate or the environmental condition to which the first flexible substrate is exposed based on the first measurement.

Aspect 37: A system configured to perform one or more operations recited in one or more of Aspects 1-36.

Aspect 38: An apparatus comprising means for performing one or more operations recited in one or more of Aspects 1-36.

Aspect 39: A non-transitory computer-readable medium storing a set of instructions, the set of instructions comprising one or more instructions that, when executed by a device, cause the device to perform one or more operations recited in one or more of Aspects 1-36.

While various embodiments have been disclosed, it will be apparent to those skilled in the art that various changes and modifications can be made which will achieve some of the advantages of the concepts disclosed herein without departing from the spirit and scope of the invention. It is to be understood that other embodiments may be utilized and structural or logical changes may be made without departing from the scope of the present invention. It should be mentioned that features explained with reference to a specific figure may be combined with features of other figures, even in those not explicitly mentioned. Such modifications to the general inventive concept are intended to be covered by the appended claims and their legal equivalents.

With regard to the various functions performed by the components or structures described above (assemblies, devices, circuits, systems, etc.), the terms (including a reference to a “means”) used to describe such components are intended to correspond, unless otherwise indicated, to any component or structure that performs the specified function of the described component (i.e., that is functionally equivalent), even if not structurally equivalent to the disclosed structure that performs the function in the exemplary implementations of the invention illustrated herein. Thus, it will be obvious to those reasonably skilled in the art that other components performing the same functions may be suitably substituted

Furthermore, the following claims are hereby incorporated into the detailed description, where each claim may stand on its own as a separate example embodiment. While each claim may stand on its own as a separate example embodiment, it is to be noted that—although a dependent claim may refer in the claims to a specific combination with one or more other claims—other example embodiments may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent on the independent claim.

It is further to be noted that methods disclosed in the specification or in the claims may be implemented by a device having means for performing each of the respective acts of these methods. For example, the techniques described in this disclosure may be implemented, at least in part, in hardware, software, firmware, or any combination thereof, including any combination of a computing system, an integrated circuit, and a computer program on a non-transitory computer-readable recording medium. For example, various aspects of the described techniques may be implemented within one or more processors, including one or more microprocessors, DSPs, ASICs, or any other equivalent integrated or discrete logic circuitry, as well as any combinations of such components.

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some embodiments, a single act may include or may be broken into multiple sub acts. Such sub acts may be included and part of the disclosure of this single act unless explicitly excluded.

What is claimed is:

1. A sensor system, comprising:
a first flexible substrate configured to undergo a deformation in response to at least one force applied to the first flexible substrate or an environmental condition to which the first flexible substrate is exposed;
a first metamaterial layer mechanically coupled to the first flexible substrate, wherein the first metamaterial layer comprises a first array of conductive elements that are mutually coupled by a first strain-dependent coupling that changes based on the deformation of the first flexible substrate;
at least one transmitter configured to transmit a first electromagnetic transmit wave towards the first metamaterial layer, wherein the first metamaterial layer is configured to convert the first electromagnetic transmit wave into a first electromagnetic receive wave based on the first strain-dependent coupling; and
at least one receiver configured to receive the first electromagnetic receive wave and acquire a first measurement of a first property of the first electromagnetic receive wave.

2. The sensor system of claim 1, wherein the at least one receiver is configured to determine a strain resulting from the at least one force applied to the first flexible substrate or the environmental condition to which the first flexible substrate is exposed based on the first measurement.

3. The sensor system of claim 1, wherein the first strain-dependent coupling includes at least one of capacitive coupling, inductive coupling, or galvanic coupling.

4. The sensor system of claim 1, wherein the first property of the first electromagnetic receive wave is a phase shift of the first electromagnetic receive wave relative to a phase of the first electromagnetic transmit wave or an amplitude shift of the first electromagnetic receive wave relative to an amplitude of the first electromagnetic transmit wave.

5. The sensor system of claim 1, wherein the first strain-dependent coupling affects a millimeter (mm)-wave property of the first metamaterial layer such that the mm-wave property changes based on the at least one force applied to the first flexible substrate or the environmental condition to which the first flexible substrate is exposed.

6. The sensor system of claim 1, further comprising:
at least one processor configured to determine a strain resulting from the at least one force applied to the first flexible substrate or the environmental condition to which the first flexible substrate is exposed based on the first electromagnetic receive wave,
wherein the at least one receiver is configured to demodulate the first electromagnetic receive wave to generate a demodulated signal, and
wherein the at least one processor is configured to evaluate the first property of the demodulated signal using at least one of phase analysis, amplitude analysis, or spectral analysis, and determine the strain based on the evaluated first property.

7. The sensor system of claim 1, wherein the deformation of the first flexible substrate causes a positional shift of the conductive elements of the first array of conductive elements relative to each other, thereby causing a change in the first strain-dependent coupling.

8. The sensor system of claim 7, wherein the deformation of the first flexible substrate causes the positional shift of the conductive elements of the first array of conductive elements relative to each other without deforming a geometry of the conductive elements of the first array of conductive elements.

9. The sensor system of claim 1, wherein:
the conductive elements of the first array of conductive elements have a first Young's Modulus and the first flexible substrate has a second Young's Modulus that is greater than the first Young's Modulus by a factor of at least 10,000.

10. The sensor system of claim 9, wherein the deformation of the first flexible substrate causes the positional shift of the conductive elements of the first array of conductive elements relative to each while a geometry of the conductive elements of the first array of conductive elements remains substantially unchanged based on a difference between the first Young's Modulus and the second Young's Modulus.

11. The sensor system of claim 1, further comprising:
a circuit substrate comprising a first rigid substrate, a second rigid substrate, and the first flexible substrate interposed between the first rigid substrate and the second rigid substrate,
wherein the first rigid substrate includes a transmit antenna configured to transmit the first electromagnetic transmit wave, and
wherein the second rigid substrate includes a receive antenna configured to receive the first electromagnetic receive wave.

12. The sensor system of claim 1, further comprising:
a circuit substrate comprising a first rigid substrate, a second rigid substrate, and the first flexible substrate interposed between the first rigid substrate and the second rigid substrate,
wherein the first rigid substrate includes a transceiver antenna configured to transmit the first electromagnetic transmit wave and receive the first electromagnetic receive wave, and
the second rigid substrate includes a reflecting structure configured to reflect an electromagnetic wave received from the first metamaterial layer back through the first metamaterial layer to the transceiver antenna.

13. The sensor system of claim 1, further comprising:
a circuit substrate comprising a first rigid substrate, a second rigid substrate, and the first flexible substrate interposed between the first rigid substrate and the second rigid substrate,
wherein the first rigid substrate includes a first coplanar waveguide configured to couple the first electromagnetic transmit wave into the first metamaterial layer, and
wherein the second rigid substrate includes a second coplanar waveguide configured to couple out the first electromagnetic receive wave from the first metamaterial layer.

14. The sensor system of claim 1, further comprising:
a second metamaterial layer mechanically coupled to the first flexible substrate, wherein the second metamaterial layer comprises a second array of conductive elements that are mutually coupled by a second strain-dependent coupling that changes based on the deformation of the first flexible substrate,
wherein the at least one transmitter is configured to transmit a second electromagnetic transmit wave at the second metamaterial layer, wherein the second metamaterial layer is configured to convert the second electromagnetic transmit wave into a second electromagnetic receive wave based on the second strain-dependent coupling, and
wherein the at least one receiver is configured to receive the second electromagnetic receive wave and acquire a second measurement of a second property of the second electromagnetic receive wave.

15. The sensor system of claim 14, wherein the at least one receiver is configured to determine a strain resulting from the at least one force applied to the first flexible substrate or the environmental condition to which the first flexible substrate is exposed based on the second measurement.

16. The sensor system of claim 14, wherein:
the at least one force comprises a first force applied to the first flexible substrate along a first axis and a second force applied to the first flexible substrate along a second axis perpendicular to the first axis, and
the at least one receiver is configured to determine a first strain based on the first measurement and determine a second strain based on the second measurement.

17. The sensor system of claim 14, wherein the first electromagnetic transmit wave is linearly polarized in a first direction and the second electromagnetic transmit wave is linearly polarized in a second direction that is non-parallel to the first direction.

18. The sensor system of claim 17, wherein:
the first metamaterial layer is sensitive to electromagnetic waves linearly polarized in the first direction and is substantially insensitive to electromagnetic waves linearly polarized in the second direction, and
the second metamaterial layer is sensitive to electromagnetic waves linearly polarized in the second direction and is substantially insensitive to electromagnetic waves linearly polarized in the first direction.

19. The sensor system of claim 17, wherein each of the conductive elements of the first array of conductive elements have a first sensitivity axis aligned with the first direction and each of the conductive elements of the second array of conductive elements have a second sensitivity axis aligned with the second direction. 20 The sensor system of claim 14, wherein the first metamaterial layer and the second metamaterial layer are formed in a common conductive layer that is mechanically coupled to the first flexible substrate.

21. The sensor system of claim 20, wherein:
the conductive elements of the first array of conductive elements are intermixed with the conductive elements of the second array of conductive elements within the common conductive layer, or
the conductive elements of the first array of conductive elements are mechanically coupled to a first region of the first flexible substrate and the conductive elements of the second array of conductive elements are mechanically coupled to a second region of the first flexible substrate, wherein the first region and the second region are mutually exclusive regions.

22. The sensor system of claim 1, further comprising:
a second metamaterial layer mechanically coupled to the first flexible substrate, wherein the second metamaterial layer comprises a second array of conductive elements that are mutually coupled to the first array of conductive elements by a second strain-dependent coupling that changes based on a separation distance between the first metamaterial layer and the second metamaterial layer,
wherein the at least one transmitter is configured to transmit the first electromagnetic transmit wave at the first metamaterial layer and the second metamaterial layer, wherein the first metamaterial layer and the second metamaterial layer are configured to convert the first electromagnetic transmit wave into a second electromagnetic receive wave based on the second strain-dependent coupling, and
wherein the at least one receiver is configured to receive the second electromagnetic receive wave and acquire a second measurement of a second property of the second electromagnetic receive wave.

23. The sensor system of claim 22, wherein the at least one receiver is configured to determine a strain resulting from the at least one force applied to the first flexible substrate or the environmental condition to which the first flexible substrate is exposed based on the second measurement.

24. The sensor system of claim 22, wherein the first metamaterial layer is arranged in a first plane of the first flexible substrate and the second metamaterial layer is arranged in a second plane of the first flexible substrate, wherein the first plane and the second plane are arranged at different transmission distances from the at least one transmitter.

25. The sensor system of claim 1, further comprising:
a second flexible substrate configured to undergo a deformation in response to the at least one force applied to the second flexible substrate or the environmental condition to which the second flexible substrate is exposed, wherein the first flexible substrate is stacked on the second flexible substrate;
a second metamaterial layer mechanically coupled to the second flexible substrate, wherein the second metamaterial layer comprises a second array of conductive elements that are mutually coupled to the first array of conductive elements by a second strain-dependent coupling that changes based on a separation distance between the first metamaterial layer and the second metamaterial layer,
wherein the at least one transmitter is configured to transmit a second electromagnetic transmit wave at the first metamaterial layer and the second metamaterial layer, wherein the first metamaterial layer and the second metamaterial layer are configured to convert the second electromagnetic transmit wave into a second electromagnetic receive wave based on the second strain-dependent coupling, and
wherein the at least one receiver is configured to receive the second electromagnetic receive wave, acquire a second measurement of a second property of the second electromagnetic receive wave, and determine at least one strain measurement based on the first and the second measurements.

26. The sensor system of claim 1, wherein the first electromagnetic transmit wave is a first polarized electromagnetic transmit wave having a first polarization and the first electromagnetic receive wave is a first polarized electromagnetic receive wave having a second polarization different from the first polarization,
wherein the first metamaterial layer is configured to convert the first polarized electromagnetic transmit wave into the first polarized electromagnetic receive wave based on the first strain-dependent coupling, wherein a difference between the first polarization and the second polarization changes based on the first strain-dependent coupling, and
wherein the at least one receiver is configured to determine a strain resulting from the at least one force applied to the first flexible substrate or the environmental condition to which the first flexible substrate is exposed based on the second polarization.

27. The sensor system of claim 26, wherein the at least one receiver is configured to measure the second polarization and determine the strain based on the measured second polarization.

28. The sensor system of claim 26, wherein the at least one receiver is configured to measure an intensity of the first polarized electromagnetic receive wave and determine the strain based on the measured intensity, wherein the measured intensity is a function of the difference between the first polarization and the second polarization.

29. A sensor system, comprising:
a waveplate comprising:
a first flexible substrate configured to undergo a deformation in response to at least one force applied to the first flexible substrate or an environmental condition to which the first flexible substrate is exposed; and
a first metamaterial layer mechanically coupled to the first flexible substrate, wherein the first metamaterial layer comprises a first array of conductive elements that are mutually coupled by a first strain-dependent coupling that changes based on the deformation of the first flexible substrate,
wherein, based on the first strain-dependent coupling, the first metamaterial layer is configured to convert a first polarized electromagnetic wave having a first polarization into a second polarized electromagnetic wave having a second polarization different from the first polarization.

30. The sensor system of claim 29, further comprising:
a reflective structure configured to reflect electromagnetic waves;
a transmitter configured to transmit a first polarized electromagnetic wave having a first polarization at the first metamaterial layer,
wherein the reflective structure is configured to receive and reflect the second polarized electromagnetic wave, thereby converting the second polarized electromagnetic wave into a third polarized electromagnetic wave having a third polarization,
wherein, based on the first strain-dependent coupling, the first metamaterial layer is configured to convert the third polarized electromagnetic wave into a fourth polarized electromagnetic wave having a fourth polarization, wherein the fourth polarization is different from the first polarization and a difference between the first polarization and the fourth polarization changes based on the first strain-dependent coupling; and
a receiver configured to receive the fourth polarized electromagnetic wave and acquire a first measurement of the fourth polarized electromagnetic wave.

31. The sensor system of claim 30, wherein the receiver is configured to determine a strain resulting from the at least one force applied to the first flexible substrate or the environmental condition to which the first flexible substrate is exposed based on the first measurement

32. The sensor system of claim 30, wherein the receiver is configured to measure the fourth polarization and determine a strain resulting from the at least one force applied to the first flexible substrate or the environmental condition to which the first flexible substrate is exposed based on the measured fourth polarization.

33. The sensor system of claim 30, wherein the receiver is configured to measure an intensity of the fourth polarized electromagnetic wave and determine a strain resulting from the at least one force applied to the first flexible substrate or the environmental condition to which the first flexible substrate is exposed based on the measured intensity, wherein the measured intensity is a function of the difference between the first polarization and the fourth polarization.

34. The sensor system of claim 30, wherein the first polarization is a first linear polarization, wherein the second polarization is a first circular polarization, wherein the third polarization is a second circular polarization opposite to the first circular polarization, and wherein the fourth polarization is a second linear polarization that is perpendicular to the first linear polarization when no stress is applied to the first flexible substrate.

35. The sensor system of claim 30, further comprising:
a second metamaterial layer mechanically coupled to the first flexible substrate, wherein the second metamaterial layer comprises a second array of conductive elements that are mutually coupled by a second strain-dependent coupling that changes based on the deformation of the first flexible substrate,
wherein the transmitter is configured to transmit a fifth polarized electromagnetic wave having a fifth polarization at the second metamaterial layer,
wherein, based on the second strain-dependent coupling, the second metamaterial layer is configured to convert the fifth polarized electromagnetic wave into a sixth polarized electromagnetic wave having a sixth polarization,
wherein the reflective structure is configured to receive and reflect the sixth polarized electromagnetic wave, thereby converting the sixth polarized electromagnetic wave into a seventh polarized electromagnetic wave having a seventh polarization,
wherein, based on the second strain-dependent coupling, the second metamaterial layer is configured to convert the seventh polarized electromagnetic wave into an eighth polarized electromagnetic wave having an eighth polarization, wherein the eighth polarization is different from the fifth polarization and a difference between the fifth polarization and the eighth polarization changes based on the second strain-dependent coupling, and
wherein the receiver is configured to receive the eighth polarized electromagnetic wave, acquire a second measurement of the eighth polarized electromagnetic wave, and determine a strain resulting from the at least one force applied to the first flexible substrate or the environmental condition to which the first flexible substrate is exposed based on the second measurement.

36. A sensor system, comprising:
a waveplate comprising:
a first flexible substrate configured to undergo a deformation in response to at least one force applied to the first flexible substrate or an environmental condition to which the first flexible substrate is exposed;
a first metamaterial layer mechanically coupled to the first flexible substrate, wherein the first metamaterial layer comprises a first array of conductive elements that are mutually coupled by a first strain-dependent coupling that changes based on the deformation of the first flexible substrate, wherein the first strain-dependent coupling includes at least one of capacitive coupling or inductive coupling; and
a linearly polarizing layer configured to polarize electromagnetic waves into a predetermined linear polarization; and
a reflective structure configured to reflect electromagnetic waves;
a transmitter configured to transmit an electromagnetic transmit wave,
wherein the linearly polarizing layer is configured to convert the electromagnetic transmit wave into a first polarized electromagnetic wave having a first polarization corresponding to the predetermined linear polarization,
wherein, based on the first strain-dependent coupling, the first metamaterial layer is configured to convert the first polarized electromagnetic wave into a second polarized electromagnetic wave having a second polarization,
wherein the reflective structure is configured to receive and reflect the second polarized electromagnetic wave, thereby converting the second polarized electromagnetic wave into a third polarized electromagnetic wave having a third polarization,
wherein, based on the first strain-dependent coupling, the first metamaterial layer is configured to convert the third polarized electromagnetic wave into a fourth polarized electromagnetic wave having a fourth polarization, wherein the fourth polarization is different from the first polarization and a difference between the first polarization and the fourth polarization changes based on the first strain-dependent coupling; and
a receiver configured to receive at least a portion of the fourth polarized electromagnetic wave, acquire a first measurement of the fourth polarized electromagnetic wave, and determine a strain resulting from the at least one force applied to the first flexible substrate or the environmental condition to which the first flexible substrate is exposed based on the first measurement.
